(19) United States
(12) Patent Application Publication
(10) Pub. No.: US 2021/0294932 A1
(43) Pub. Date: Sep. 23, 2021

(54) MOBILE SYSTEM AND METHOD FOR DESIGNING A STORMWATER MANAGEMENT SYSTEM USING GREEN INFRASTRUCTURE

(71) Applicant: 3Rwater, Inc., Honolulu, HI (US)

(72) Inventor: Lauren Venu, Honolulu, HI (US)

(73) Assignee: 3Rwater, Inc., Honolulu, HI (US)

(21) Appl. No.: 17/185,853

(22) Filed: Feb. 25, 2021

Related U.S. Application Data
(60) Provisional application No. 62/992,929, filed on Mar. 21, 2020.

(51) Int. Cl. G06F 30/13; G06F 30/12

(52) U.S. Cl. CPC G06F 30/13; G06F 2113/08; G06F 30/12

(57) ABSTRACT

A mobile system and method for designing a stormwater management system using green infrastructure is described. The mobile system and method is used to (1) identify a location and quantity of stormwater runoff generated on an existing property; (2) provide a user with an optimum size and location for a rain catchment tank, rain garden, or other green infrastructure system for retaining or otherwise managing such stormwater runoff on the existing property; and (3) quantify stormwater runoff reduction potential based upon the optimized size and location of the green infrastructure. The mobile system and method utilize a mobile device, such as a tablet or smartphone, and includes aspects of data aggregation, visualization, compilation and sorting of information that can be viewed as a list, a chart, a map view, and the like, for administrative purposes, such as obtaining utility rebates or fee credits, or other green infrastructure asset management.

### CROSS-REFERENCE TO RELATED APPLICATIONS

This application claims the benefit of U.S. Provisional Application No. 62/992,929 titled “Mobile System and Method for Designing a Stormwater Management System Using Green Infrastructure,” filed Mar. 21, 2020, which is hereby incorporated herein by reference in its entirety for all purposes.

### BACKGROUND

Permanent stormwater management systems can include a variety of device technologies. Among them, rain gardens, rain catchment, permeable pavement, tree wells, biofilters, bioretention, and dry wells are often referred to as “green infrastructure.” Stormwater capture projects and methods that increase the efficiency of water use, and landscaping to promote groundwater recharge, may also be coined as “green infrastructure.” Green infrastructure principles may be considered at many levels of stormwater management strategy to build community resilience.

Stormwater refers to any form of water deriving from rain, and is sometimes used interchangeably with the terms “rainwater,” “graywater,” or “greywater.” Challenges associated with regulatory requirements concerning stormwater runoff—such as nutrient and sediment export into waterbodies (e.g., streams, lakes and coastal habitats) and limited fresh water supplies, flooding, and building community resilience—create tasks too large for a single actor or sector to address alone. Green infrastructure projects, such as rain gardens to increase recharge into groundwater supplies, or rainwater catchment to reuse rainwater for outdoor irrigation and/or indoor use, are identified needs. In tandem, educational curricula for raising awareness in school-age children, to help them understand responsible watershed citizenship as a measure of building resiliency, is also an identified need.

Methods for water erosion management incorporating topography, soil type, and weather statistics have been previously described. Computer-implemented methods for modeling rooftop runoff potential and asset management have also been previously described, as have methods and apparatus for determining rainfall loss (runoff) using remote geographic sensing. These technologies, however, fail to provide means for estimating an amount of stormwater runoff reduction expected from using green infrastructure, or means for computing, for example, an optimal size for a stormwater green infrastructure system device. Such technologies in stormwater management are therefore not well-suited for teaching green infrastructure principles to individuals and communities of individuals (such as children and property owners), or for designing or monitoring the efficiency of single-property (home or facility) and/or community green infrastructure systems. In addition, they cannot be used to assist in calculating potential financial incentives for installing various sizes and types stormwater capture devices that also support municipal billing systems for stormwater management.

At the level of devices, retrofit catch basins for use in stormwater management practice have also been previously described. Similarly, a description of a handheld, graphical user interface (GUI) personal digital assistant (PDA) receiver used for collecting agronomic and GPS position data is also pre-existing. Yet, such previously described devices do not enable the user of a handheld (or mobile) device to incorporate collected field data into a computer-implemented system for analyzing the stormwater reduction impact of a green infrastructure system, or for analyzing stormwater runoff captured by green infrastructure. Such technologies also fail to incorporate means for optimizing green infrastructure systems for the property under consideration, including its geolocation and historical (or other) rainfall data, or means for computing the property's associated stormwater runoff volumes with and without green infrastructure. Thus, such earlier technologies cannot serve as means to enable users to obtain water utility rebates or credits from governments, insurance or other agencies, nor as means to enable asset management by those agencies.

With respect to educational tools for studying surface permeability and stormwater runoff in an urban environment (as for example, in a schoolyard), manual, pencil-and-paper methods have been previously used for collecting data and reviewing rainwater runoff Manual educational tools for stormwater management are extremely limited, however, because aggregating data and information across a collection of properties, for the purposes of processing and compiling analytics, monitoring the impacts of green infrastructure installations, offering incentives to design and install green infrastructure systems, and/or monitoring stormwater runoff and green infrastructure asset management are not enabled by any manual method.

In addition to the technical failings of these earlier-described systems and methods, such technologies are inadequate and lacking in myriad other ways, such as, for example: (1) having insufficient mobility and inadequate or nonexistent data aggregation/analysis tools for design, planning, environmental study, monitoring or asset management purposes; and/or (2) having cumbersome and unadaptable user interfaces that are poorly-suited to a layperson's use, and equally poorly-suited as an educational tool for teaching green infrastructure principles and methods to students, educators and property owners. Furthermore, none of the earlier-described systems and methods offer a mobile solution to the problem of designing a scalable stormwater management system using green infrastructure which includes, among other things, (1) computing an optimal size for a green infrastructure system type (e.g., a rain garden or catchment tank) based on a property's drainage area, (2) computing the amount of annual stormwater runoff reduction expected from using a green infrastructure system, based on the geo location and using local rainfall data, and (3) calculating potential financial incentives for installing various size and types stormwater capture devices that also support municipal billing systems for stormwater management.

What is needed, therefore, is a mobile system and method to support the placement and optimal size of a stormwater management system that uses green infrastructure, as well as monitoring the design, installation and use of that green infrastructure. Technologies that can serve to increase the recharge of groundwater resources, encourage the use of onsite water supplies, reduce the use of potable water for landscaping irrigation, and protect the water quality in limited natural resources, are sorely needed. Educational systems and methods that can easily and effectively teach watershed citizenship at a young age as part of an educational curriculum are also beneficial and needed, as well as tools that support green infrastructure incentives and provide a mechanism for green infrastructure asset management.

### SUMMARY

A system of one or more computers can be configured to perform particular operations or actions by virtue of having software, firmware, hardware, or a combination of them installed on the system that, in operation, causes or cause the system to perform the actions. One or more computer programs can be configured to perform particular operations or actions by virtue of including instructions that, when executed by data processing apparatus, cause the apparatus to perform the actions. One general aspect includes a method for designing a management system for stormwater runoff. The method includes: identifying a drainage mechanism for channeling rainwater falling onto an existing property (public or private; improved or unimproved); classifying a surrounding area associated with the drainage mechanism; determining a drainage area associated with the existing property; obtaining a verified (i.e., “verifying”) geolocation for the existing property; verifying an amount of rainfall for the geolocation; selecting a green infrastructure system for capturing the stormwater runoff, based upon the drainage mechanism, the drainage area, the surrounding area, and the amount of rainfall (e.g. an average annual rainfall amount) for the geolocation; computing an optimal size for the green infrastructure system; and computing at least one value associated with stormwater runoff reduction expected from using the green infrastructure system for retaining, draining, or otherwise managing stormwater runoff at the geolocation. Other embodiments of this aspect include corresponding computer systems, apparatus, and computer programs recorded on one or more computer storage devices, configured to perform the actions of the methods (such as a non-transitory computer-readable medium having stored thereon computer-executable instructions which, when executed by an information processing device, cause the information processing device to perform the actions of the methods described herein).

Implementations may include one or more of the following features. The green infrastructure system may be used for filtering stormwater runoff, or for retaining stormwater runoff, such as for example, a rain garden or a rain catchment tank (others are described below). The drainage mechanism may be, for example, a channeling device or open storm drain (others are described below). Implementations of the described techniques include hardware components for input data collection, processing and display, and a method or process embodied in computer software on a computer-accessible medium (or media), including a cloud-based data processing system and/or one or more data storage and management systems.

One general aspect includes a method for monitoring one or more green infrastructure projects associated with a stormwater management system. The method includes storing aggregated information in a database, where the aggregated information includes a plurality of database records, which may include: date of record, a geolocation for an existing property, information associated with a drainage mechanism at the geolocation, information associated with a drainage area associated with the geolocation (such as, e.g., size or dimensions of the drainage area, a rainfall amount for the geolocation, and/or stormwater runoff volume computed for the drainage area and the rainfall amount), one or more classifiers associated with a surrounding area associated with the drainage mechanism, information identifying a green infrastructure system for retaining, draining, or otherwise managing stormwater runoff at the geolocation, an optimal size for the device, at least one value associated with stormwater runoff reduction expected from using the green infrastructure system at the geolocation, at least one value associated with stormwater runoff volume expected from using the green infrastructure system at the geolocation. The method also includes accessing, analyzing, and displaying the aggregated database information. Other embodiments of this aspect include corresponding computer systems, apparatus, and computer programs recorded on one or more computer storage devices, configured to perform the actions of the methods, (such as a non-transitory computer-readable medium having stored thereon computer-executable instructions which, when executed by an information processing device, cause the information processing device to perform the actions of the methods described herein). In a further aspect, the geolocation may be a GPS location (i.e., verified GPS coordinates), or a tax map key (TMK) that identifies a property with a boundary. Other systems and/or methods for specifying a geolocation of an existing property may be used. One optional feature includes the ability to record whether a proposed green infrastructure project is submitted in draft or accepted in final form.

Practical applications of these inventions may include, among others: (1) flood control; (2) post-construction stormwater runoff management (e.g., establishment of permanent stormwater “best management practices”); (3) water quality control (e.g., watershed protection); (4) management of stormwater utility fee reductions or credits; (5) rebates and grants for green infrastructure; (6) flood insurance credits; (7) asset management; and (8) educational outreach and educational use.

### BRIEF DESCRIPTION OF THE DRAWINGS

FIG. 1 shows a schematic diagram for one aspect of a method for designing a management system for stormwater runoff using the system described herein.

FIG. 2A illustrates steps for storing, accessing, and outputting aggregated information regarding a stormwater management system designed according to the system and method described herein.

FIG. 2B is a schematic diagram for one aspect of the system to perform the method described herein.

FIG. 3 presents a Table I that may be used, in one aspect, for computing at least one value associated with stormwater runoff reduction expected from using a green infrastructure system comprising a rain catchment tank for retaining, draining, or otherwise managing stormwater runoff at a geolocation.

FIGS. 4A and 4B collectively illustrate a Table II that may be used, in one aspect, for computing an optimal size for a selected green infrastructure system comprising a rain garden, as used in one further aspect of the method for designing a stormwater management system using green infrastructure.

FIG. 5 illustrates one exemplary context for using the system and method described herein, as a mobile application to a user, who provides relevant input data about the property.

FIG. 6 is a schematic process diagram (flowchart) for functional aspects of one aspect of the mobile system and method, described herein, for designing a stormwater management system using green infrastructure.

FIG. 7 illustrates one aspect of a mobile application graphical user interface (GUI) for an administrator, to enable the administrator to set up an Admin account and register as an administrator of that account.

FIG. 8 illustrates one general aspect of input data captured or otherwise entered by a property owner and transmitted to a mobile application of the system to implement the method described herein.

FIG. 9 illustrates one aspect of a mobile application GUI for a user login.

FIG. 10 illustrates one aspect of identifying an “Opportunity” for green infrastructure using the system and method of the present subject matter described herein.

FIG. 11 illustrates one aspect of collecting information about the “Opportunity” using the system and method of the present subject matter described herein.

FIG. 12 illustrates one aspect of identifying a drainage area and verifying historical rainfall data using the system and method of the present subject matter described herein.

FIG. 13 illustrates one aspect of selecting the type of green infrastructure to be implemented in designing a stormwater management system using the system and method described herein.

FIG. 14 illustrates one aspect of data analysis using the system and method of the present subject matter described herein.

FIG. 15 illustrates one aspect of an offline mode using the system and method of the present subject matter described herein.

FIG. 16 illustrates one aspect of an administrator login feature using the system and method of the present subject matter described herein.

FIG. 17 illustrates one aspect of output data analysis and information available to an administrator for aggregated input data entered by users and transmitted to the mobile application of the system and method of the present subject matter.

FIG. 18 provides a closer view of some screen shots, showing exemplary output data analysis and information available to an administrator for aggregated input data entered by users of the system described herein.

FIGS. 19A, 19B, 19C, and 19D collectively illustrate one aspect of how an administrator may view user input data using the system and method of the present subject matter described herein.

FIGS. 20A and 20B illustrate one aspect of how an administrator may finalize data, which is stored in a database, using the system and method of the present subject matter described herein.

FIGS. 21A and 21B collectively illustrate one aspect of data storage and data management using the system and method of the present subject matter described herein.

FIG. 22 illustrates one aspect of a system architecture used for designing a stormwater management system using green infrastructure systems, according to the subject matter described herein.

### DETAILED DESCRIPTION

1. Method for Designing a Stormwater Management System Using Green Infrastructure Systems

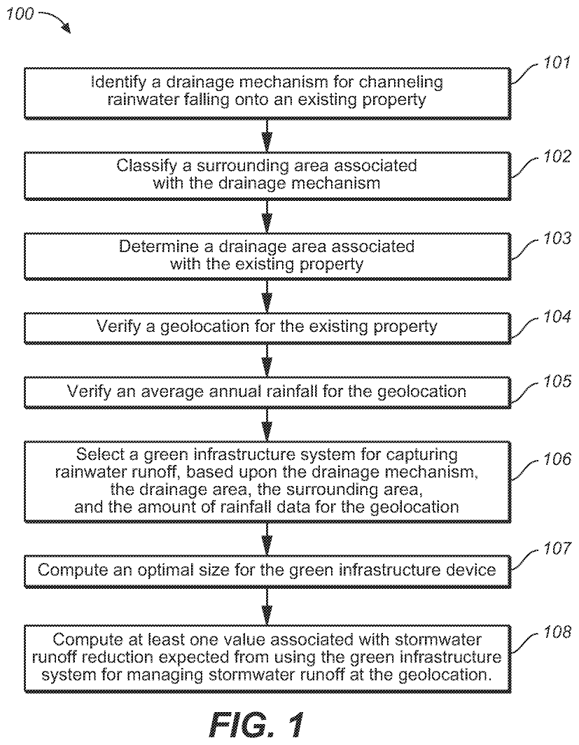

FIG. 1 shows a schematic diagram for one aspect of a method 100 for designing a management system for stormwater runoff using the system described herein. In this aspect, the method steps are accomplished using a mobile application on a mobile computer processing device (such as a tablet with an integrated camera), and include:
a) identifying a drainage mechanism 14 for channeling rainwater falling onto an existing property 10 (Step 101)—this is accomplished by capturing a photo 12 using the built-in camera of a smartphone or other mobile computer processing device (further described below);
b) classifying a surrounding area 18 associated with the drainage mechanism 14 (Step 102)—this may be accomplished by, for example, offering the user a set of choices and prompting a selection among them. Thus, in one aspect, the user can select from one or more dropdown lists, e.g: (1) Terrain angle profile (e.g., flat, sloping toward the opportunity, sloping away from the opportunity); and/or (2) Surface type (e.g. grassy, pavement, small garden, other)
c) determining a drainage area 20 associated with the existing property 10 (Step 103)—this may be accomplished by providing a mapping measuring tool to draw a polygon to manually define the drainage area 20. In this aspect, a polygon area is calculated automatically.
d) verifying a geolocation 16 for the existing property 10 (Step 104)—this may be accomplished by using, for example, a camera function of the mobile device enabling the method (e.g., a smartphone). In this aspect, a Google Maps API is used to verify GPS coordinates; although any other type of equivalent mapping program may be used.
e) verifying an amount of rainfall for the geolocation 16 (Step 105)—this may be accomplished using one or more third-party proprietary data sources, open source rainfall data (such as, e.g., average annual rainfall data for the geolocation 16), and/or rainfall data accessible from personal or facility owned rain gauges;
f) selecting a green infrastructure system 26 for capturing stormwater runoff, based upon the drainage mechanism 14, the surrounding area 18, the drainage area 20, and the amount of rainfall 24 (e.g., average annual, or other historical data or measure, or real-time measure) for the geolocation 16 (Step 106)—this may be accomplished by offering the user a set of choices and prompting a selection among them, for example: (1) Rain Catchment; and (2) Rain Garden (e.g., Bioretention).
g) computing an optimal size 27 for the green infrastructure system 26 (Step 107)—this may be accomplished by defining a set of relevant parameters (further described below), such as natural and engineered soil conditions, rainfall, drainage area, and retention time in the green infrastructure system 26; and
h) computing at least one value associated with stormwater runoff reduction expected from using the green infrastructure system 26 for managing stormwater runoff at the geolocation 16 (Step 108) (further described below)—this may be accomplished by, for example, computing the estimated volume of water expected to be captured using average annual rainfall or actual rainfall measured during a selected period of time (or other historical data or measure), and then dividing it by the total expected stormwater runoff during these same conditions, to arrive at a percent reduction of stormwater runoff based on the size and type of green infrastructure system 26 chosen for retaining, draining, or otherwise managing stormwater runoff.

Additionally, in the above aspect, the drainage mechanism 14 (sometimes coined “gray infrastructure”) may be any type of stormwater runoff channeling device such as, for example, a culvert, an open storm drain, a catch basin, an exposed or open downspout, curb(s) with adjacent vegetation, or concrete or impervious surface impeding penetration of rainwater into the ground, or an unimproved (natural) area. In some aspects, green infrastructure system 26 selections offer additional options to the rain garden and catchment tank options, in which case methods for computing optimal size 27 for green infrastructure system 26 selected for geolocation 16 will accommodate appropriate parameters for a green infrastructure system 26 option, as will methods for computing expected stormwater runoff reduction. Permeable pavement, green roofs, dry wells, bioswales, and biofilters offer such other green infrastructure system options.

Note also that a green infrastructure system 26 may be selected to provide filtering, infiltrating and/or retaining stormwater runoff.

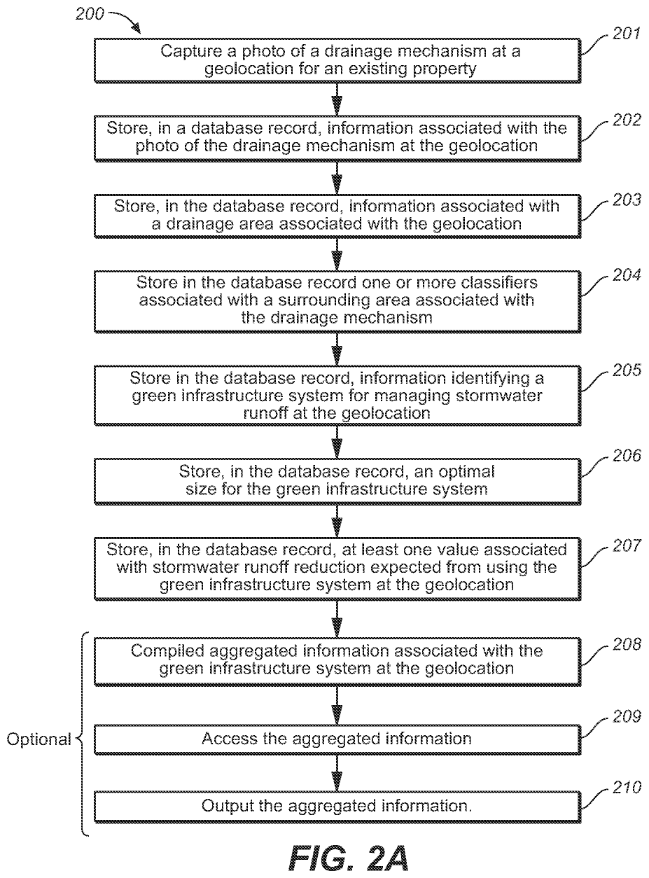

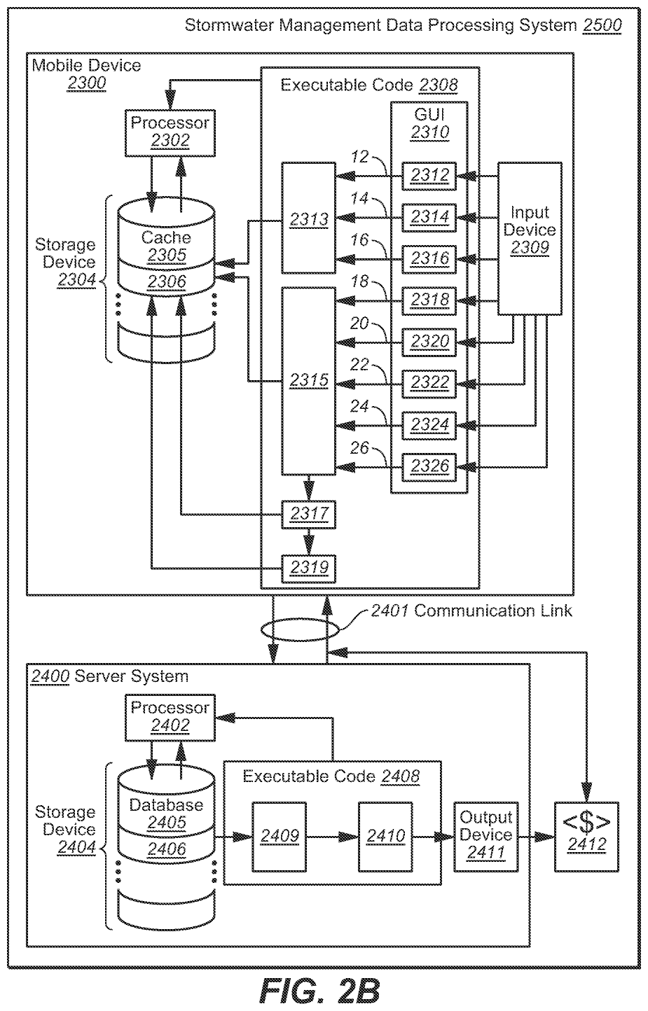

A system and method for monitoring at least one green infrastructure project 30 associated with a stormwater management is also described. One such aspect is shown in FIGS. 2A and 2B. which illustrate method steps (shown in FIG. 2A) for storing, accessing, and displaying aggregated information, which (as shown in FIG. 2B) may be stored in a data structure 2405 (such as, for example, a database) on a server storage system 2404, which may include a cloud-based system, a data warehouse, or an application infrastructure. Components of a green infrastructure project 30, as described herein, generally includes:
a) a geolocation 16 for an existing property 10 (which may be determined as described above);
b) information associated with a drainage mechanism 14 at the geolocation 16;
c) information associated with a drainage area 20 associated with the geolocation 16;
d) at least one classifier 21 associated with a surrounding area 18 associated with the drainage mechanism 14;
e) information identifying a green infrastructure system 26 for retaining, draining, or otherwise managing stormwater runoff at the geolocation 16;
f) an optimal size 27 for the green infrastructure system 26;
g) at least one value 29 associated with stormwater runoff reduction expected from using the green infrastructure system 26 at the geolocation 16; and
h) at least one value 25 associated with stormwater runoff volume expected from using the green infrastructure system 26 at the geolocation 16.

One optional step of the method described herein includes computing an expected annual stormwater runoff volume at the existing property without green infrastructure. A further optional step includes determining an equivalent impervious area treated or removed by the system described herein, based on the type and size of green infrastructure used or chosen; additionally, a further optional step includes calculating a fee credit or rebate monetary value associated with the type and size green infrastructure system entered.

Referring to FIG. 2A, one aspect of the method comprises:
(Step 201) capturing a photo 12 of a drainage mechanism 14 at a geolocation 16 for an existing property 10;
(Step 202) storing, in a database record 2306, information associated with photo 12 of drainage mechanism 14 at geolocation 16;
(Step 203) storing, in database record 2306, information associated with a drainage area 20 associated with geolocation 16;
(Step 204) storing, in database record 2306, at least one classifier 21 associated with a surrounding area 18 associated with drainage mechanism 14;
(Step 205) storing, in database record 2306, information identifying a green infrastructure system 26 for managing stormwater runoff at geolocation 16;
(Step 206) storing, in database record 2306, an optimal size 27 for green infrastructure system 26; and
(Step 207) storing, in database record 2306, at least one value associated with stormwater runoff reduction expected from using the green infrastructure system 26 at the geolocation 16.

Optional, additional steps may include:
(Step 208) compiling aggregated information 2410 associated with green infrastructure system 26 at geolocation 16;
(Step 209) accessing aggregated information 2410; and
(Step 210) outputting aggregated information 2410.

FIG. 2B shows a schematic diagram of one aspect of a data processing system that may be used to perform the above-described method(s). In this aspect, the data processing system comprises a mobile device 2300 including at least one computer processor 2302, an input device 2309, and a computer-readable storage device 2304 informationally coupled to the computer processor 2302. A data structure 2305 is stored in the computer-readable storage device 2304 and informationally coupled to the computer processor 2302. In one aspect, data structure 2305 (e.g. a cache) comprises a database record 2306. Executable code 2308 is embodied in the computer-readable storage device 2304 for execution by the computer processor 2302. When executing on the computer processor 2302, executable code 2308 causes a graphical user interface 2310 to be displayed on the input device 2309.

As further described below, in one aspect, the graphical user interface (GUI) 2310 of FIG. 2B is configured to:
a) capture a photo 12 (GUI screen 2312) of a drainage mechanism 14 (GUI screen 2314) at a geolocation 16 (GUI screen 2316) for an existing property 10;
b) store, in the database record 2306, information 2313 associated with photo 12 of drainage mechanism 14 at geolocation 16;
c) determine information 2315 associated with a drainage area 20 (GUI screen 2320) associated with geolocation 16;
d) permit a user to select at least one classifier 21 associated with a surrounding area 18 (GUI screen 2318) associated with drainage mechanism 14; and
e) permit a user to select a green infrastructure system 26 (GUI screen 2326) for managing stormwater runoff at the geolocation 16.

Executable code 2308, when executing on the computer processor 2302, further provides computing means 2317 for (a) calculating an optimal size 27 for the green infrastructure system 26, and (b) calculating at least one value 29 associated with stormwater runoff reduction associated with using green infrastructure system 26 for managing stormwater runoff at geolocation 16.

In one aspect, an optional feature of the system may include a fee reduction processing means 2319 for determining utility fee reductions or rebates: Based on geolocation 16 (e.g. confirmed GPS coordinates or TMK entered by a user) executable code 2306 of mobile device 2300 accesses customer utility fee information 2412 for location 16. Based on the size and type of green infrastructure practice the user enters via input device 2309 and graphical user interface 2308, fee reduction processing means 2319 estimates a monthly and/or annual fee reduction for geolocation 16. Optionally, a computed area of treated or removed impervious area and estimated fee credit for geolocation 16 is saved to storage device 2304 and/or storage device 2404.

In the above aspects, an administrator is enabled to perform a variety of analytics on the aggregated information, which is derived from the users input data regarding the property and green infrastructure selected. For example, in one aspect, the administrator is enabled to inspect the aggregated information and to qualify the green infrastructure system 26 as acceptable for installation at the geolocation 16. Following installation and verification of the green infrastructure system 26 being installed, the administrator is enabled to indicate that status (as, for example, “installed”) and record any associated information relevant to green infrastructure asset management (e.g., a date and time of installation, verification, subsequent inspections or maintenance, etc.).

Thus, as shown in FIG. 2B, in one aspect, mobile device 2300 is informationally coupled to a server system 2400 via a communication link 2401. Server system 2400 itself comprises a server processor 2402, a server storage system 2404 for storing a data structure 2405 (e.g., a database). In this aspect, one or more processes 2409 are embodied in executable code 2408 which, when executing on server processor 2402, permits a user of the server system to (a) create aggregated information 2410 associated with green infrastructure system 26 (entered via GUI screen 2316) or installed or proposed for installation at geolocation 16 (entered via GUI screen 2316), and (b) display such aggregated information on an output device 2411. Thus, the system permits the administrator to inspect individual database record 2406 for an individual property, and/or aggregated information 2410, thereby facilitating evaluation of green infrastructure system 26 selected or proposed for installation at geolocation 16 (2316). Customer utility fee information 2412 is then communicated to mobile device 2300 over communication link 2401. Customer utility fee information 2412 may include, for example, TMK, total impervious area, monthly/annual bill, and any fee credit(s), rebates and grants available.

The administrator may also inspect user accounts to remove objectionable material, as well as to delete database records, if warranted. Data collected by the user (using, e.g., the mobile application method of FIG. 1), along with information derived from processing that data, is stored in an application infrastructure system that includes a database of aggregated information; the application infrastructure system (which may also include forgotten password reset options and data analytics) may be implemented on a cloud-based server, although other application infrastructure systems and/or other database storage systems may be used. Access to the aggregated information and input data stored in the database allows the administrator to inspect user accounts, remove objectionable material, separate out bad data in the database storage, and analyze and evaluate the aggregated information as a mechanism for green infrastructure asset management. A user's aggregated information and input data may remain accessible on the mobile device used to collect/enter the input data, even if deleted from the database.

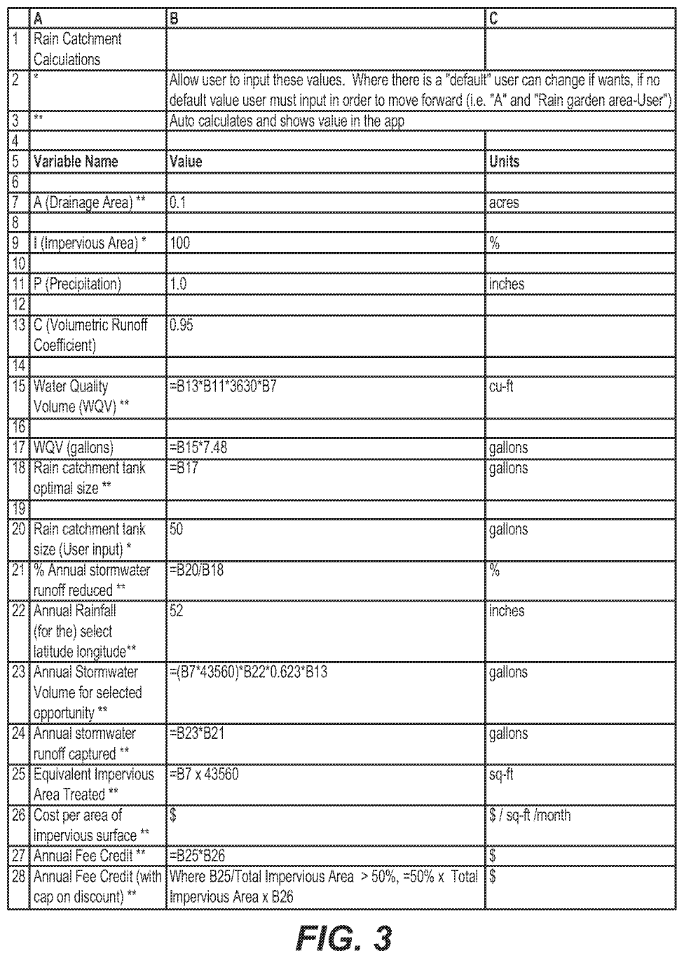

FIG. 3 illustrates a spreadsheet that may be used for computing at least one value associated with stormwater runoff reduction expected from using a green infrastructure system 26 comprising a rain catchment tank for retaining, draining, or otherwise managing stormwater runoff at a geolocation 16. In this example, FIG. 3 presents Table I, which illustrates a spreadsheet that may be used for rain catchment modelling, where the first column in Table I is name of a model variable, and the second column is a value for the model variable of the first column—that value may be either a fixed user input value (in some aspects, the value may be retrieved automatically from an external database, e.g., aggregated rainfall data from rain gauges or sensors), or a value calculated by the system (in which case, Table I shows the formula used for the calculation). The third column of Table I is units of the value of the second column.

A description and/or explanation of the Rain Catchment Calculations of the example shown in FIG. 3, using fixed user input value or the value calculated by the system based on the other variables, is as follows (Notations: *=Allow user to input these values (default values may be used for some entries; if no default value is available, then user input is required to move forward in mobile application 502); **=Auto calculates and displays value via mobile application 502):

| Variable Name | Equation or Set Value |
|---|---|
| A (Drainage Area) ** | This is automatic when the user draws out the |
| | area in the map function - convert square |
| | feet to acres |
| I (Impervious Area) * | default 100% - allow user to change |
| P (Precipitation) | defaults at 1 (assumes 1″ storm is the 90th |
| | percentile storm event -i.e. all rain events |
| | that occur 90% of the time are at or below |
| | 1″/24 hr) |
| C (Volumetric Runoff | 0.05 + 0.009 × I (locked) |
| Coefficient) | |
| Water Quality Volume | C × P × 3630 × A (auto calculates but |
| (WQV) ** | is not shown on user interface) |
| WQV (gallons) | WQV × 7.48 |
| Rain catchment tank | |
| optimal size ** | |
| Rain catchment tank | User inputs size rain catchment tank. |
| size (User input) * | |
| % Annual stormwater | (Catchment volume (User)/Optimal Tank Size |
| runoff reduced ** | (model)) * 100. The value will not exceed |
| | 90%. If the user inputs the optimal size |
| | value to default at 90%. If user inputs |
| | size greater than optimal size, default |
| | value is 90%. If the user enters a value |
| | that creates a % less than 90%, the % |
| | runoff calculated is calculated by the |
| | Rain Catchment tank size entered by the |
| | User divided by the Optimal size provided |
| | by the app software. |
| Annual Rainfall (for | Rainfall data from geolocation where the |
| the select latitude | photo was taken |
| longitude) ** | |
| Annual Stormwater | Drainage Area × Annual Stormwater Volume |
| Volume for selected | (inches) × 0.623 × C (annual |
| opportunity ** | stormwater volume = inches provided |
| | by rain sensor/gauge data) |
| Annual stormwater | Percent Annual runoff reduction (%) × |
| runoff captured ** | Annual Stormwater volume for selected |
| | opportunity |
| Equivalent Impervious | Equals the Drainage Area (A) in square-feet |
| Area Treated ** | |
| Cost per area of | Locked - Value based on geolocation ($/sq-ft) |
| impervious surface ** | from utility. |
| Annual Fee Credit ** | Equivalent Area Treated × $/Impervious |
| | Area) × 12. May include a cap based on |
| | the location. |
| Annual Fee Credit | Where Equivalent Pervious Area Treated/Total |
| (with cap on | Impervious Area > 50%, calculate 50% × |
| discount) ** | Total Impervious Area × Annual Fee Credit; |
| | Replaces Cost per area of impervious surface |
| | for geolocations where fee credit has a cap |
| | and Equivalent Impervious Area exceeds cap. |
| | Pulls in utility's customer billing data. |
| | The % of area of Equivalent Impervious Area |
| | Treated to the total impervious area within |
| | the property boundary shall not exceed the % |
| | allowed for a fee credit. In example (Annual |
| | Fee Credit) if the fee credit is capped at |
| | 50% the total fee credit permitted is where |
| | the Equivalent Impervious Area is no greater |
| | than 50% of the total impervious area within |
| | the property boundary and if it exceeds 50% |
| | the app defaults to 50%. |

In this example, as shown in Table I (Column B, Row 7), the drainage area 20 (variable name “A”) is determined from user input (e.g. using draw polygon GUI screen 2320), and calculated to be 0.1 acres; rainfall data 24 (Column B, Row 22) is derived from geolocation 16 metadata (as captured from photo 12) to be 52 inches. In the example shown in Table I, the stormwater runoff without green infrastructure is calculated by multiplying a drainage area 20 (as computed from user input, further described in detail below) by a value representing local rainfall data, and using coefficient of 0.623 to convert to gallons. The rain catchment size is determined by the drainage area 20 (“A”) and is converted from square-feet to acres by dividing the square-feet by 43560. The value for the number of acres is multiplied by the percentage of impervious cover (“I”) (Column B, Row 9), then multiplied by a precipitation rate (“P”) (Column B, Row 11) (as shown, defaults at 1 inch over 24 hours), multiplied by a coefficient of efficiency (“C”) (Column B, Row 13) (as shown, locked at 95 percent) and then multiplied by a conversion factor to covert units to gallons, to arrive at a Water Quality Volume (“WQV”) (Column B, Row 17) to be captured by the catchment tank. The WQV represents the 90^{th} percentile storm event (measurement of rainfall that occurs at or under 90% of the time). The WQV then is calculated by mobile device 2300 and provides an optimal size 27 rain catchment system (Column B, Row 18), which is equal to the WQV. The mobile device 2300 calculates a percent of stormwater runoff captured based on the size rain catchment tank (Column B, Row 21) by dividing the optimal rain catchment tank size by the WQV multiplied by 0.9 by 100. Mobile device 2300 then calculates an annual stormwater volume captured with the optimally-sized catchment system (Column B, Row 24), by multiplying the calculated annual average stormwater runoff value (Column B, Row 23) with the percent captured by the annual stormwater runoff volume (Column B, Row 21). Annual average stormwater volume (Column B, Row 23) for the drainage area (A) is calculated by multiplying the A by 43560 by the average annual rainfall for that geolocation (Column B, Row 22) by 0.623 by C (the efficiency of stormwater runoff) from Column B, Row 13.

In one aspect, a rainwater catchment tank size is computed as: rainwater catchment tank=WQV*7.48 (gallons). In a further aspect, rain catchment tank size may be manually entered by the user.

In the above aspect where an optimal size rainwater catchment tank is entered, a percent annual stormwater runoff reduction is then calculated by the following:

Percent Annual Stormwater Runoff Reduction=A/I*0.9*100

where

A=Area of the rain garden/rain catchment tank

I=computed rain garden/rain catchment size as calculated by the mobile device

In one aspect, the value for “Percent Annual Stormwater Runoff Reduction” defaults to 90 percent if the above calculation exceeds 90 (Column D, Row 21), since the design storm is set at the 90^{th} percentile storm event to account for precipitation anomalies.

In another aspect where the size rainwater catchment tank entered is less than the optimal size rainwater catchment tank, the percent annual stormwater runoff reduction is then calculated by the following:

Percent Annual Stormwater Runoff Reduction=Rain catchment tank sized entered by the user/Optimal size rainwater catchment tank

The Percent Annual Stormwater Runoff Reduction (Column B, Row 21) is then multiplied by an Annual Stormwater Runoff volume (Column B, Row 23), to calculate a volume (Column A, Row 24) (in gallons captured) associated with the size of the catchment tank.

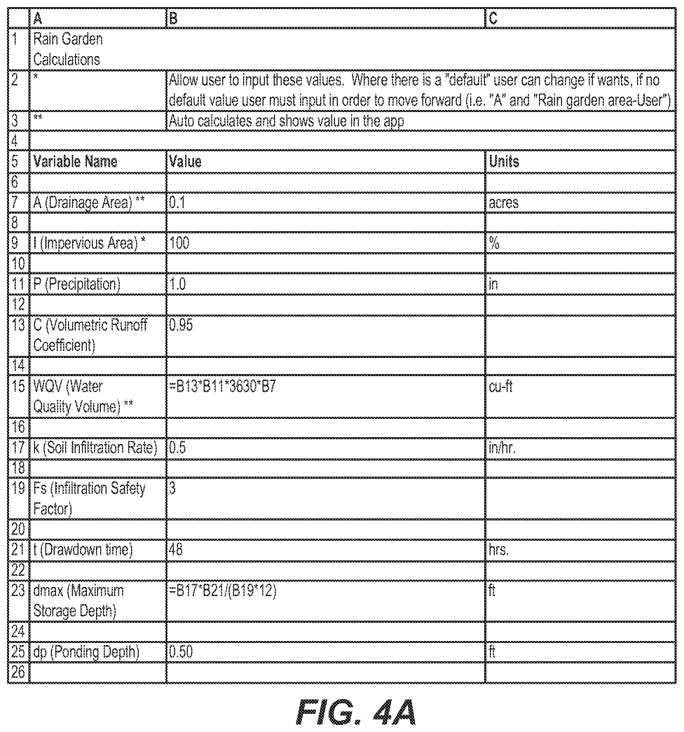

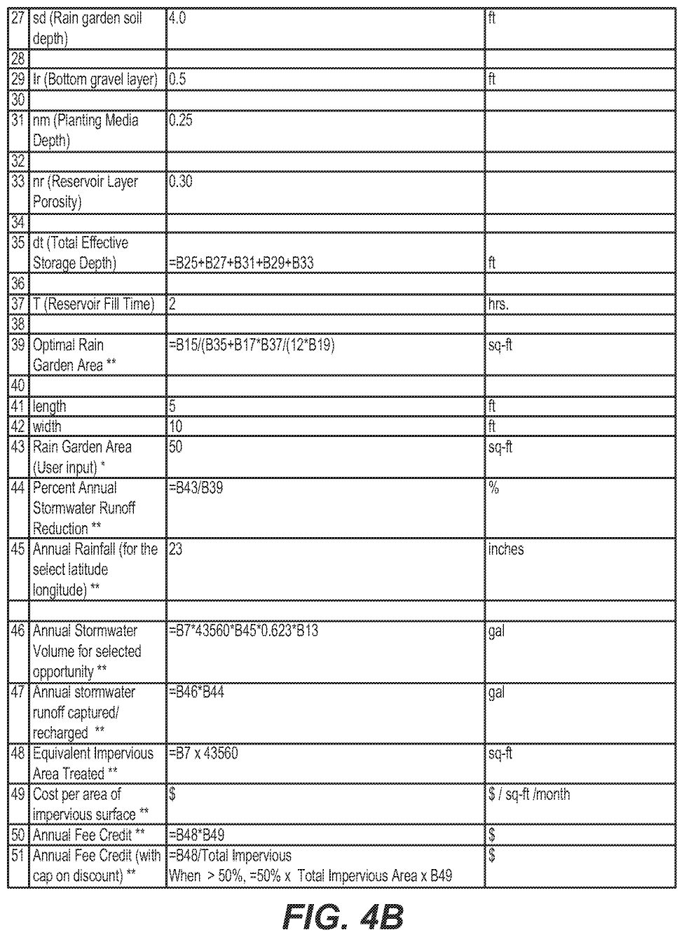

FIGS. 4A and 4B collectively present Table II, which illustrates a spreadsheet that may be used for computing an optimal size 27 for a selected green infrastructure system 26 comprising a rain garden, where the first column in Table II is name of a model variable, the second column is a value for the model variable of the first column, and the third column is units of the variable.

A description and/or explanation of the Rain Garden Calculations of the example of FIGS. 4A and 4B, using fixed user input value or the value calculated by the system based on the other variables, is as follows (Notations: *=Allow user to input these values (default values may be used for some entries; if no default value is available, then user input is required to move forward in mobile application 502); **=Auto calculates and displays value via mobile application 502):

| Variable Name | Equation or Set Value |
|---|---|
| A (Drainage Area) ** | This is automatic when the user draws |
| | out the area in the map function - |
| | converts square feet to acres (divide |
| | value by 43560) |
| I (Impervious Area) * | defaults at 100% |
| P (Precipitation) | defaults at 1 (assumes 1″ storm is |
| | the 90th percentile storm event -i.e. |
| | all rain events that occur 90% of the |
| | time are at or below 1″/24 hr) |
| C (Volumetric Runoff | 0.05 + 0.009 × I (Locked) |
| Coefficient) | |
| WQV (Water Quality | C × P × 3630 × A (auto-calculates |
| Volume) ** | based on “A” - not shown on app |
| | interface) |
| k (Soil Infiltration | Locked at 0.5 |
| Rate) | |
| Fs (Infiltration | Locked at 3 |
| Safety Factor) | |
| t (Drawdown time) | Locked at 48 hrs. |
| dmax (Maximum | Locked at 0.7 |
| Storage Depth) | |
| dp (Ponding Depth) | Locked at 0.5 |
| sd (Rain garden | default at 4 (locked in current version) |
| soil depth) | |
| Ir (Bottom | default at 0.5 |
| gravel layer) | |
| nm (Planting | Locked at 0.25 |
| Media Depth) | |
| nr (Reservoir | Locked at 0.3 |
| Layer Porosity) | |
| dt (Total | Calculated in app (locked) |
| Effective Storage | |
| Depth) | |
| T (Reservoir | Locked at 2 hrs. |
| Fill Time) | |
| Optimal Rain | WQV/(dt + 1/36) Optimal rain garden size |
| Garden Area ** | captures 90% of all storm events. Example - |
| | if the rain garden is this size then the |
| | assumption is the annual stormwater runoff |
| | volume can be reduced by 90% |
| length | User entered (optional, can just enter Rain |
| | garden area) - not in current version. For |
| | (future) professional version) |
| width | User entered (optional, can just enter Rain |
| | garden area) - not in current version. For |
| | (future) professional version) |
| Rain Garden Area | |
| (User input) * | |
| Percent Annual | (Rain Garden Area (User)/Rain Garden Area |
| Stormwater Runoff | (model)) × 100) If a user overrides the |
| Reduction ** | optimal default size and inputs a value for |
| | the Rain Garden that is greater than the |
| | default size, the software defaults to 90% |
| | reduced. If the user enters a value that |
| | creates a % less than 90%, the % runoff |
| | calculated is the Rain Garden area entered |
| | by the User divided by the optimal size Rain |
| | Garden provided by the app model. |
| Annual Rainfall (for | Rainfall data from the geo-location where the |
| the select latitude | photo was taken |
| longitude) ** | |
| Annual Stormwater | Drainage Area × Annual Stormwater Volume |
| Volume for selected | (inches) × 0.623 × “C” (annual |
| opportunity ** | stormwater volume = inches provided by |
| | rainfall data from sensors/gauges) |
| Annual stormwater | Percent Annual runoff reduction (%) × Annual |
| runoff captured/ | Stormwater volume for selected opportunity |
| recharged ** | |
| Equivalent Impervious | Equals the Drainage Area (A) in square-feet |
| Area Treated ** | |
| Cost per area of | Locked - Value based on geolocation ($/sq-ft) - |
| impervious surface ** | from utility |
| Annual Fee Credit ** | Equivalent Area Treated × $/Impervious Area) × |
| | 12. May include a cap based on the location. |
| Annual Fee Credit | Replaces B50 for geolocations where fee credit |
| (with cap on | has a cap and Equivalent Impervious Area |
| discount) ** | exceeds cap. Pulls in utility's customer |
| | billing data. The % of area of B49 to the total |
| | impervious area within the property boundary |
| | shall not exceed the % allowed for a fee credit. |
| | In example (B51) if the fee credit is capped at |
| | 50% the total fee credit permitted is where the |
| | Equivalent Impervious Area is no greater than |
| | 50% of the total impervious area within the |
| | property boundary and if it exceeds 50% the |
| | app defaults to 50%. |

In this aspect, and as illustrated in Table II (FIGS. 4A and 4B), stormwater runoff without green infrastructure is calculated by multiplying a drainage area 20 (variable name “A”), determined from user input, by a value representing local rainfall data, and using coefficient of 0.623 to convert to gallons. In this aspect, calculation of rain garden sizes uses the following variables: A=Drainage Area; I=Impervious Area; P=Precipitation; C=Volumetric Runoff Coefficient; WQV=Water Quality Volume; k=Soil Infiltration Rate; Fs=Infiltration Rate Safety Factor; t=Drawdown time; dmax=Maximum Storage Depth; dp=Ponding Depth; sd=Planting Media Depth; Ir: Reservoir Layer (Gravel) Depth; nm=Planting Media Depth; nr=Reservoir Layer Porosit; dt=Total Effective Storage Depth; T=Reservoir Fill Time. In this example, an optimal rain garden size (Column B, Row 39) is calculated as follows:

The drainage area 20 multiplied by the percentage of impervious cover (Column B, Row 9), then multiplied by a precipitation rate (Column B, Row 11) (as shown, locked at 1 inch over 24 hours), multiplied by a coefficient of efficiency (as shown, locked at 95 percent), and then multiplied by 7.48 to covert units to gallons, to arrive at the Water Quality Volume (WQV) (Column B, Row 15) to be captured by the rain garden. In one particular aspect, the WQV value is based upon a value of stormwater runoff occurring by storm intensities 90 percent of the time (90th percentile storm event).

In one aspect, an optimal size 27 (Column B, Row 39) for a rain garden is computed by considering soil infiltration rate (Column B, Row 17), infiltration safety factor (Column B, Row 19), drawdown time (Column B, Row 21) maximum storage depth (Column B, Row 23), ponding depth (Column B, Row 25), rain garden soil depth (Column B, Row 27). depth of bottom gravel layer (Column B, Row 29), planting media depth (Column B, Row 31), total effective storage depth (Column B, Row 35), and reservoir fill time (Column B, Row 37). In one aspect, for example, the following calculation to determine a rain garden size is used:

Optimal rain garden size=WQV/(dt+k*T/(12*Fs))

where

WQV=Water Quality Volume

dt=Total effective storage depth

k=Soil infiltration rate

T=Reservoir fill time

Fs=Infiltration rate safety factor

In a further aspect, rain garden size may be manually entered. The Percent Annual Stormwater runoff reduction is then calculated as described previously.

2. Functional Aspects: Administrator and User Interfaces and System Features

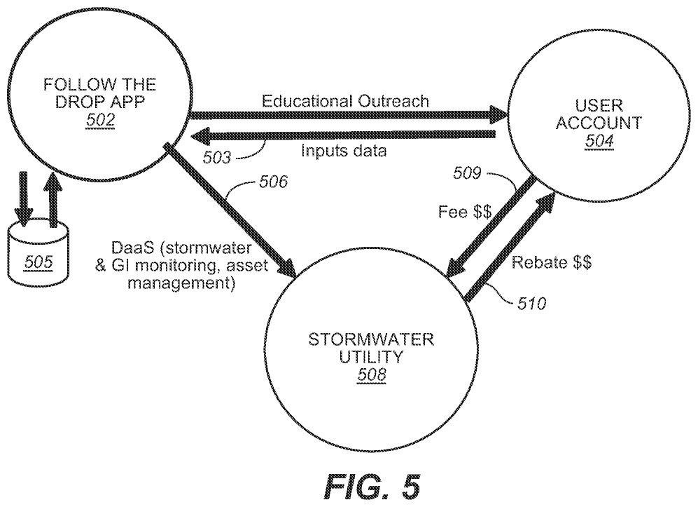

FIG. 5 illustrates one exemplary context for using the system and method described herein. A mobile application 502 (referred to herein as, “Follow the Drop”) facilitates educational outreach and engagement to a user (for example, a property owner), who creates a user account 504 provides relevant input data 503 about an existing property 10. In one aspect, the mobile application 502 processes the user's input data 503, stores the input data 503 in a cloud database 505, and provides data analytics (e.g., chart, list and map views) as “Data as a Service (DaaS)” outputs 506 to the user and an administrator associated with the user account 504. The administrator may be, for example, a stormwater utility administrator 508, who may use the data analytics outputs 506 and user input data 503 of the system to a reduce utility fee 509 and/or offer a utility fee rebate 510 to user account 504; data analytics outputs 506 may also be used as an asset management tool to track the status and locations of green infrastructure systems and projects. The system and method enable monitoring stormwater runoff volumes and green infrastructure projects at various phases and locations.

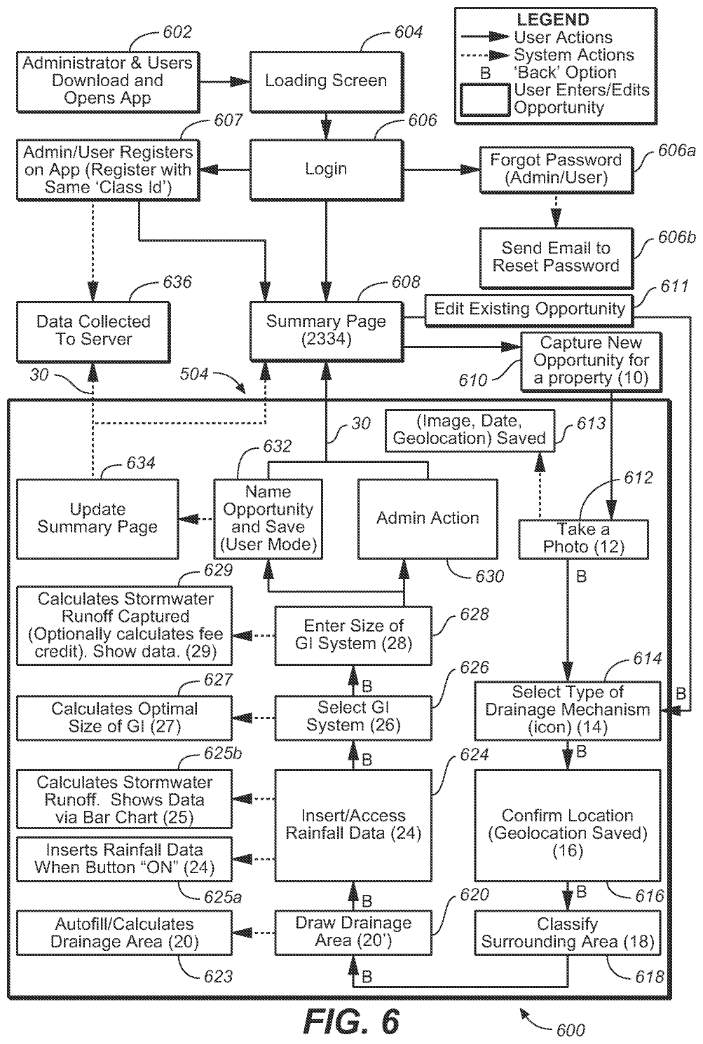

FIG. 6 is a schematic process diagram (flowchart) for functional aspects of one aspect of the mobile system and method, described herein, for designing a stormwater management system using green infrastructure systems. In this aspect, and referring to FIG. 5 and FIG. 6, mobile process 600 includes elements for performing the methods as follows:
Process 602: User/Admin: Downloads mobile application 502 on mobile device 2300. Admin/User opens the mobile application 502 and registers and logs in to a user account 504. Process 602 calls to process 604.
Processes 604, 606, 606a, 606b, 607: Features of these processes include: a graphical user interface loading process 604; a login process 606, which is configured to (1) call to a registration process 607, and (2) call to a password request process 606a and email password reset process 606b. Registration process 607 is further configured to call to a Data-Collected-To-Server process 636 when data is collected by a user of mobile application 502 and stored in cloud database 505. The user can login online and then use mobile application 502 in offline mode (further described below) after logging in. Processes 606 and 607 call to process 608.
Process 608 displays a summary page 2334 on GUI 2310 configured to provide summary information (e.g. 2313, 2315 and (optionally) 2412), and also to allow a user account 504 to (1) capture a new opportunity (by virtue of a call to Capture-New-Opportunity process 610), or (2) update an existing green infrastructure project 30 (by virtue of a call to Edit-Existing-Opportunity process 611), for example, to update a photo associated with green infrastructure project 30. Process 608 also receives calls from processes 630 (described below), 632 (described below) and 634 (described below).
Process 612: Mobile device 2300 provides a camera 2301 used to take a photo of a green infrastructure opportunity on an existing property. Take-A-Photo process 612 provides a GUI screen 2312 (for user account 504 of mobile application 502) configured to capture opportunity information 613, which may include an image (photo 12) having associated with it a date 12a and a time 12b, and location services providing a location information 12c for the image (photo 12). Process 612 calls to process 614.
Process 614: Select-Drainage-Mechanism process 614 provides a GUI screen 2314 (for user account 504 of mobile application 502) configured to identify a drainage mechanism 14 as captured in the image of photo 12. Process 614 calls to process 616.
Process 616: Confirm-Location process 616 provides a GUI screen 2316 (for user account 504 of mobile application 502) configured to confirm, verify and/or enter geolocation 16, and then save the geolocation 16 to storage device 2304. Process 616 calls to process 618.
Process 618: Classify-Surrounding-Area process 618 provides a GUI screen 2318 (for user account 504 of mobile application 502) configured to classify a surrounding area 18 by prompting selection of a classifier 21 from a user. Process 618 calls to process 620.
Process 620: Draw-Drainage-Area process 620 provides a GUI screen 2320 (for user account 504 of mobile application 502) configured to prompt drainage area information 20′ from a user (e.g., this may be accomplished by providing a mapping measuring tool on GUI screen 2320 prompting a user to draw a polygon, so as to manually define a 2-dimensional drainage area 20′. In this aspect, a drainage area is calculated automatically by process 623. Process 620 calls to processes 623 and 624.
Process 623: Compute-Drainage-Area process 623 is configured to autofill or calculate a drainage area 20 from the 2-dimensional drainage area 20′(polygon) drawn by the user at Draw-Drainage-Area process 620. Process 623 is configured to store drainage area 20 in storage device 2304 of mobile device 2300.
Process 624: Insert-Rainfall-Data process 624 provides a GUI screen 2322 (for user account 504 of mobile application 502) configured to prompt a user to manually enter or confirm rainfall data 24 at geolocation 16. Process 624 calls to processes 625a and 625b.
Processes 625a and 625b: Insert-Rainfall-Data process 625a permits a user account 504 to store an annual or other amount of rainfall 24 selected by the user over a certain period of time; in one aspect, this is information is brought into mobile device 2300 via an API call to either an open source or private rain gage data set. Calculate stormwater runoff process 625b calculates and displays the stormwater runoff volumes based on the drainage area and rainfall confirmed by the user. Processes 625a and 625b are configured to store rainfall data 24 and stormwater runoff data 25 (respectively) in storage device 2304 of mobile device 2300.
Process 626: Select-GI-System process 626 provides a GUI screen 2326 (for user account 504 of mobile application 502) configured to prompt a user to select (from a set of options) green infrastructure system 26 sought to be evaluated, proposed and/or installed at geolocation 16. Process 626 calls to processes 627 and 628.
Process 627: Calculate-Optimal-GI-Size process 627 is configured to calculate, display and store an optimal size 27 for green infrastructure system 26, based on (a) the type of green infrastructure selected from the user via process 626, (b) drainage area 20 computed and stored via process 623, and (c) rainfall data 24 confirmed and stored via processes 624 and 625a. Process 627 is configured to store optimal size 27 in storage device 2304 of mobile device 2300.
Process 628: Enter-GI-Size process 628 (optional) provides a GUI screen 2324 (for user account 504 of mobile application 502) configured to prompt a user to manually enter a size 28 for green infrastructure system 26 sought to be evaluated, proposed and/or installed at geolocation 16. Process 628 calls to processes 629, 630 and 632.
Process 629: Calculate-Stormwater-Runoff process 629 is configured to (a) calculate stormwater runoff data 29 representing an amount of stormwater runoff captured by green infrastructure system 26, (b) display stormwater runoff data 29 (via, e.g., a bar chart), and (c) optionally display impervious area treated or removed and any stormwater utility fee credit associated with user account 504.
Process 630: Admin-Action process 630 is configured to allow an Administrator an ability to: (a) review the information and data entered, created, and/or stored during processes 612-629 described above; (b) qualify a user account 504 for utility fee credits or rebates; and (c) change a green infrastructure project 30 status (for example, from “Draft” to “Final,” “Submitted”, “Approved”, “Installed,” “Maintained”). For example, the system may be used to facilitate estimating utility fee reductions and/or eligibility for grants or rebates for the type and size of a green infrastructure design solution a user selects; such estimates may then be communicated, via one or more communication link 2401 to municipal or other government databases or FTP sites to support municipal stormwater utility billing systems. Process 630 calls to process 608.
Process 632: Name-Opportunity process 632 provides a GUI screen 2327 (not shown) (for user account 504 of mobile application 502) configured to name and save green infrastructure project 30 to mobile storage device 2304. Process 632 calls to processes 608 and 634.
Process 634: Update-Summary-Page process 634 is configured to (a) update information (e.g. 2313, 2315, and (optionally) 2412) pertaining to green infrastructure project 30 which is to be displayed on summary page 2334 by process 608 (described above), and (b) send that information to process 636 for subsequent transmittal to server system 2400. Process 634 calls to processes 608 (described above) and 636.
Process 636: Data-Collected-to Server process 636 provides is configured to permit data to be confirmed and/or stored in an application infrastructure, for example using Amazon Web Services (AWS) comprising server storage device 2404. Such application infrastructure also includes (among other features) forgotten password reset options, database management and data analytics. Database management may include data and information entered by a user of mobile device 2300 via GUI 2310, as well as and updated billing information 2412 for user account 504 for the utility such as impervious area treated or removed and associated eligible fee credit or rebate.

As further discussed below, optional processes (not shown) may include: a process that calculates the potential nitrogen, phosphorus, and total suspended solids captured, and displays the value captured; a process that calculates and displays an equivalent impervious area treated or removed; a process that provides the status of green infrastructure project 30 and displays the data and information relating to that project with ranking, sorting, and status options in map (with droplets of locations of the saved projects), chart, and list view.

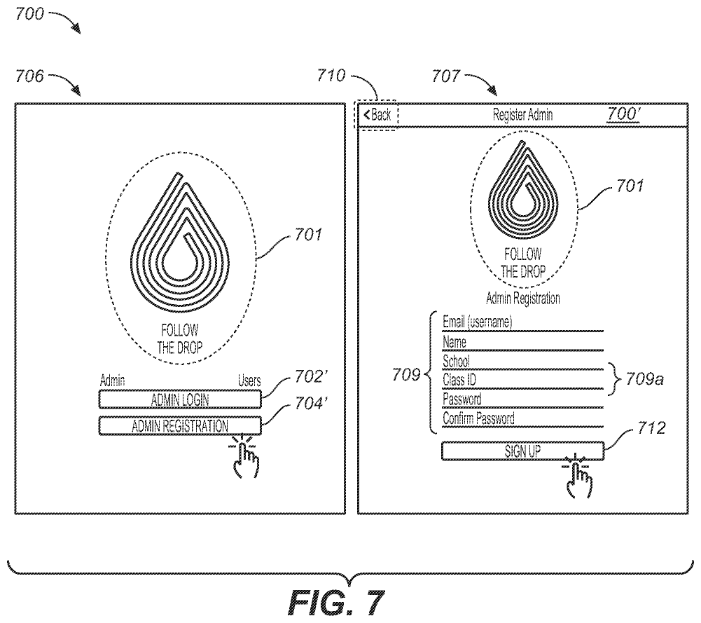

FIG. 7 depicts screenshots on touch screen input device 2309 of mobile device 2300, showing one aspect of a login screen 706 and a registration screen 707 of a GUI 700 for an administrator. In this aspect, GUI 700 may be used to enable data input for processes 606 and 607 (see FIG. 6), which allow the administrator to set up an administrator (“Admin”) account 702 and to register a set of Admin information 708 as an administrator of that account. The administrator may be a government agency, insurance company, agency, association, or utility. In this aspect, the Admin account 702 is associated with a Class ID 709a, which is assigned during admin registration process 607 (see FIG. 6), and will be the same Class ID 709a assigned to a user account 504; Class ID 708a thus links one or more user accounts (and their data) to the Admin account 702 identified by the Class ID 708a.

As shown in FIG. 7, in one aspect, administrator login screen 706 of GUI 700 comprises: (1) a logo (or other form of branding information) 701; (2) an Admin Login button 702′ (associated with process 606); and (3) an Admin Registration button 704′ (associated with process 607). In one aspect, administration registration screen 707 of GUI 700 comprises: (1) a title bar 700′; (2) the logo (or other form of branding information) 701; (3) a back button 710 for returning to administration login screen 706; (4) a set 709 of input fields (709a, . . . , etc.) to register Admin information 709 such as, for example, email address, name, school, Class ID (709a), and password; and (5) a sign-up button 712, for confirming and login process and advancing to a next associated process (e.g., process 636 or process 608).

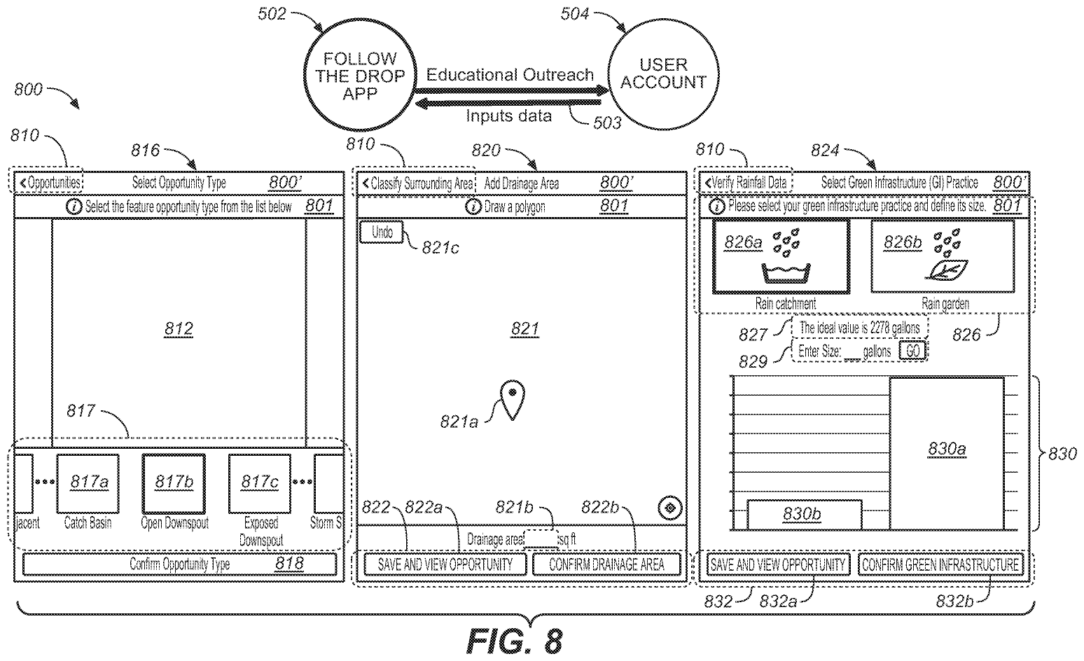

FIG. 8 depicts three screenshots of mobile application GUI 800 (see also 2310 of FIG. 2B) for a user account 504 (e.g., a property owner or other user of the system), which may be used to input data 503 captured or otherwise entered by the user and transmitted to mobile application 502 of the system to implement the method described herein. In this aspect, GUI 800 may be used to enable data input for processes 610, 612, 613, 614, 616, 618, 620, 623, 624, 625a, 625b, 626, 627, 628, 629 and 632 (see FIG. 6). In one aspect, GUI 800 comprises: (1) a select opportunity screen 816; (2) an add drainage area screen 820; and (3) a select green infrastructure screen 824. In one aspect, each screen 816, 820, and 824 comprises (among others): (1) a title bar 800′; (2) an information/instructions button 801, for providing a user of GUI 800 additional information and/or instructions on how to enter information using the displayed GUI screen); and (3) a back button 810, for returning to the previously displayed screen.

Additionally, in further aspects, and as shown in FIG. 8:
select opportunity screen 816 is associated with processes 610, 612, 613 and 614, and further comprises: (1) an image 812 of the opportunity (from captured photo 12); (2) a listing of icons 817 showing various types of drainage mechanisms (817a, 817b, 817c . . . , etc., such as, for example, a catch basin, open downspout, exposed downspout, etc.) and prompting a user selection for one type of drainage mechanism 14; and (3) a confirm opportunity button 818, for confirming data input and/or calculated for processes 610, 612, 613, and 614, and for advancing to a next associated process (e.g., process 618).
add drainage area screen 820 is associated with processes 616, 618, 620 and 623, and further comprises: (1) an interactive displayed map 821 for manually drawing a polygon shape around a geolocation 16 (as indicated by a pin 821a in displayed map 821), so as to designate a drainage area 20; (2) a drainage area size entry/display 821b; (3) an undo button 821c; and (3) a confirmation bar 822, comprising (a) save and view opportunity button 822a, and (b) a confirm drainage area button 822b, for confirming data input and/or calculated for processes 616, 618, 620, and 623, and for advancing to a next associated process (e.g., process 624).
select green infrastructure screen 824 is associated with processes 624, 625a, 625b, 626, 627, 628, 629 and 632, and further comprises: (1) an listing of icons 826 displaying various types of green infrastructure systems (e.g., rain catchment 826a, rain garden 826b, etc.) and prompting a user selection for a type of green infrastructure system 26; (2) an ideal value display 827, for displaying an optimal size 27 (for selected green infrastructure 26), as computed by process 627; (3) a size entry location 829, for manually entering a size (capacity) of selected green infrastructure 26; (4) a bar chart 830 showing a stormwater runoff volume comparisons for (a) expected runoff 830a with installation of selected green infrastructure 26, versus (b) actual runoff 830b without a green infrastructure; and (5) a confirmation bar 832, comprising (a) save and view opportunity button 832a, and (b) a confirm drainage area button 832b, for confirming data input and/or calculations for processes 626, 627, 628, 629, and 632, and for advancing to a next associated process (e.g., process 634 or process 609).

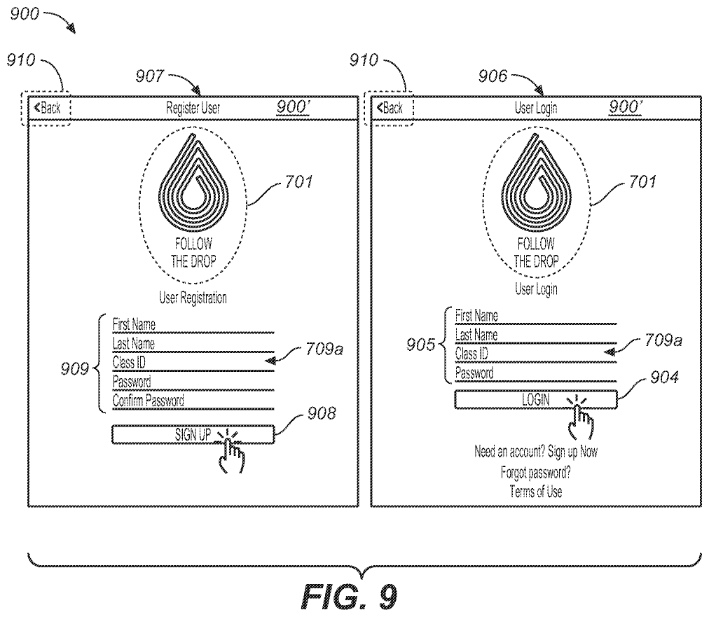

FIG. 9 depicts two screenshots of a mobile application GUI 900 (see also 2310 of FIG. 2B) for a user account 504 (e.g., a property owner or other user of the system), which may be used for user login. In this aspect, a user of a given Admin ID creates a login name and password. In some aspects, related users (such as, for example, property owners, planners, engineers, members of a community group, school students, etc.) will use the same “ID” as the administrator to link to one administrator's account. After registering as a user, the user will login to start using the mobile application executing on a mobile computer processing device. Registration and login features of a GUI 900 are similar to the registration and login features of GUI 700, namely: in one aspect, user login screen 906 of GUI 900 comprises: (1) logo (or other form of branding information) 701; (2) a User Login button 904 (associated with process 606); and (3) an User login information area 905 (associated with process 606). In one aspect, user registration screen 907 of GUI 900 comprises: (1) a title bar 900′; (2) the logo (or other form of branding information) 701; (3) a back button 910 for returning to user login screen 906; (4) a set 909 of input fields (909a, . . . , etc.) to register user information 909 such as, for example, email address, name, school, Class ID (709a), and password; and (5) a sign-up button 908 (associated with processes 636 and 608).

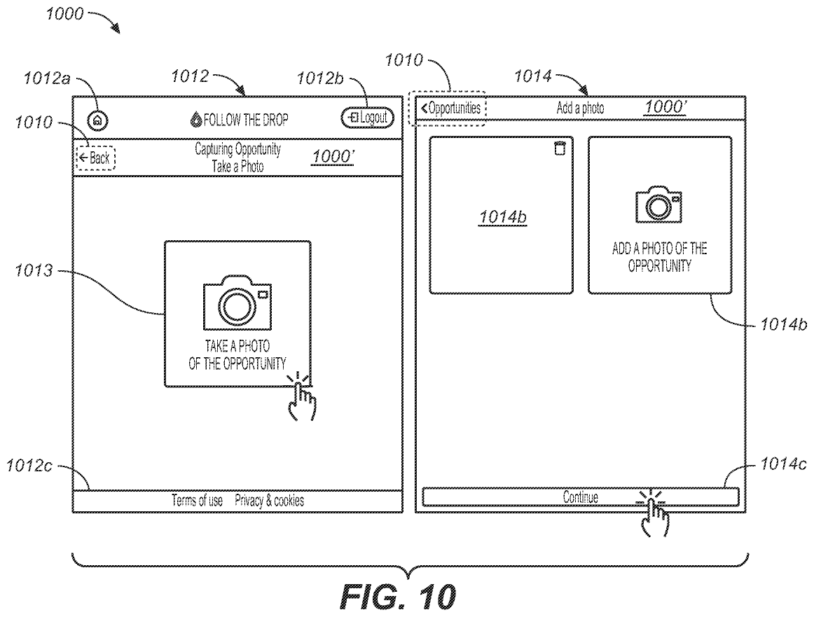

FIG. 10 depicts two screenshots of a mobile application GUI 1000 (see also 2310 of FIG. 2B) for a user account 504 (e.g., a property owner or other user of the system), which may be used for identifying an “Opportunity” for green infrastructure using the system and method of the present subject matter described herein. In this aspect, the user will be prompted to capture a photo 12 of an opportunity where a rain garden, rainwater harvesting tank, or other green infrastructure system could be implemented. The captured photo 12 creates a geolocation 16 that is stored in by the system, to be used later for mapping and spatial analysis. In this aspect, GUI 1000 may be used to enable data input for processes 610, 611, 612, and 613 (see FIG. 6). In one aspect, GUI 1000 comprises: (1) a capture opportunity/take a photo screen 1012; and (2) an add a photo screen 1014. In one aspect, each screen 1012 and 1014 comprises (among others): (1) a title bar 1000′; and (3) a back button 1010, for returning to the previously displayed screen.

Additionally, in further aspects, and as shown in FIG. 10:
capture opportunity/take a photo screen 1012 is associated with processes 610 and 612, and further comprises: (1) an interactive, real-time image 1013 of the opportunity (as captured by a camera feature of mobile device 2300); (2) home button 1012a; (3) logout button 1012b; and (4) an information bar 1012c, which permits a user to access and review information pertaining to, for examples, terms of use, privacy policy and cookies policy.
add a pho to screen 1014 is associated with processes 611 and 613, and further comprises: (1) an image 1014a of a photo 12 captured from real-time image 1013; (2) an add photo of opportunity button 1014b; and (3) a continue bar 1014c, for (a) confirming data input and (b) saving image 1014a and other information (such as date and/or geolocation 16 of photo 12), associated with 611 and 613, and for advancing to a next associated process (e.g., process 614).

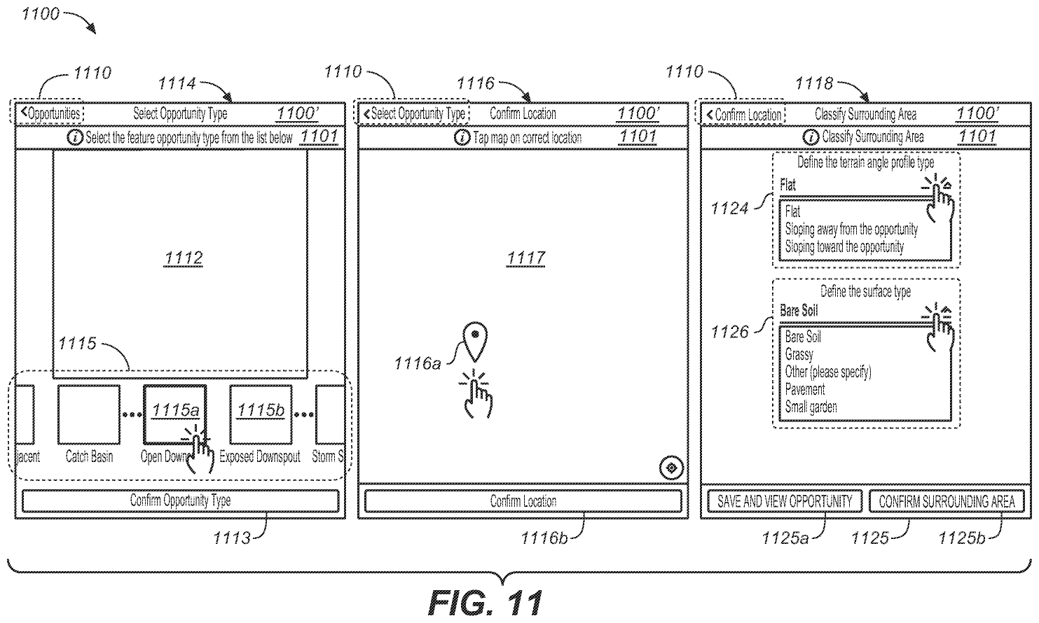

FIG. 11 depicts three screenshots of a mobile application GUI 1100 (see also 2310 of FIG. 2B) for a user account 504 (e.g., a property owner or other user of the system), which may be used for collecting information about an “Opportunity” using the system and method of the present subject matter described herein. In this aspect, and as further described below, a user will select an icon of drainage mechanism 14 (such as, for example, a catch basin open downspout, exposed downspout, or other opportunity to convert to a green infrastructure system) that best represents captured photo 12. Since captured photo 12 has a stored geolocation 16, a pin 1116a will appear on a displayed map 1119 (e.g. Google Earth) (as shown in confirm location screen 1116). The user may move pin 1116a to a precise location of the opportunity identified by, for example, tapping the screen. Next, the user will be prompted to classify the surrounding area 18 (further described below), which can be used to decide which green infrastructure system 26 would the best choice for geolocation 16. In other aspects, other map and/or geolocation tools could be used.

Thus, in this aspect, GUI 1100 may be used to enable data input for processes 614, 616, and 618 (see FIG. 6). In one aspect, GUI 1100 comprises: (1) a select opportunity screen 1114; (2) a confirm location screen 1116; and (3) a classify surrounding area screen 1118. In one aspect, each screen 1114, 1116, and 1118 comprises (among others): (1) a title bar 1100′; (2) an information/instructions button 1101, for providing a user of GUI 1100 additional information and/or instructions on how to enter information using the displayed GUI screen); and (3) a back button 1110, for returning to the previously displayed screen.

Additionally, in further aspects, and as shown in FIG. 11:
select opportunity screen 1114 is associated with process 614, and further comprises: (1) an image 1112 of the opportunity (from captured photo 12); (2) a listing of icons 1115 showing various types of drainage mechanisms (1115a, 1115b, . . . , etc., such as, for example, a catch basin, open downspout, exposed downspout, etc.) and prompting a user selection for one type of drainage mechanism 14; and (3) a confirm opportunity type bar 1113, for confirming data input for process 614, and for advancing to a next associated process (e.g., process 616).
confirm location screen 1116 is associated with process 616, and further comprises: (1) an interactive displayed map 1117 having a pin 1116a associated with geolocation 16; interactive displayed map 1117 may be used for manually moving pin 1116a to a precise location of captured photo 12 (by, for example, tapping a touch screen of mobile device 2300); and (3) a confirmation bar 1116b, for confirming data input for process 616, and for advancing to a next associated process (e.g., process 618).
classify surrounding area screen 1118 is associated with process 618, and further comprises: (1) an first listing of options 1124 to allow a user to define a terrain angle profile type (e.g., flat, sloping away from the opportunity, sloping toward the opportunity, etc.); and (2) a second listing of options 1126 to allow the user to define a surface type (e.g., bare soil, grassy, pavement, small garden, etc.), and prompting a user selection for a classifying type of a surrounding area 18; and (5) a confirmation bar 1125, comprising (a) save and view opportunity button 1125a, and (b) a confirm surrounding area button 1125b, for confirming data input for process 618, and for advancing to a next associated process (e.g., process 620).

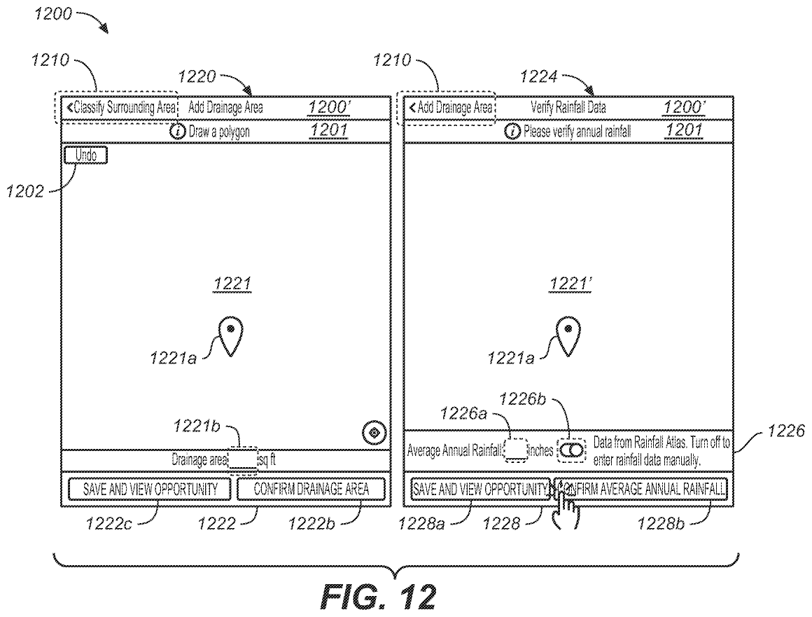

FIG. 12 depicts two screenshots of the mobile application GUI 1200 (see also 2310 of FIG. 2B) for a user account 504 (e.g., a property owner or other user of the system), which may be used for identifying a drainage area 20 and verifying historical rainfall data 24 using the system and method of the present subject matter described herein. In this aspect, a user will be prompted to use an embedding polygon tool to draw an area that is draining to their opportunity. The mobile application will then calculate drainage area 20. Next, the user can either enter the amount of annual rainfall or, if such information is maintained in an accessible database (such as, for example, in the Hawaii Rainfall Atlas, available for State of Hawaii), annual average rainfall based on the opportunity's geolocation may be enabled to automatically populate. In other aspects, the system may be synchronized to one or more live rainfall gauges, to get real-time rainfall volumes over a defined period of time, to be used in place of (or in addition to) historical annual average rainfall data.

Thus, in this aspect, GUI 1200 may be used to enable data input for processes 624, 625a, and 625b (see FIG. 6). In one aspect, GUI 1200 comprises: (1) an add drainage area screen 1220; and (2) a verify rainfall data screen 1224. In one aspect, each screen 1220 and 1224 comprises (among others): (1) a title bar 1200′; (2) an information/instructions button 1201, for providing a user of GUI 1200 additional information and/or instructions on how to enter information using the displayed GUI screen); and (3) a back button 1210, for returning to the previously displayed screen.

Additionally, in further aspects, and as shown in FIG. 12:
add drainage area screen 1220 is associated with processes 620 and 623, and further comprises: (1) interactive displayed map 1221 for manually drawing a polygon shape around geolocation 16 (as indicated by a pin 1221a), so as to designate a drainage area 20; (2) a drainage area size entry/display 1221b; (3) an undo button 1202; and (3) a confirmation bar 1222, further comprising (a) save and view opportunity button 1222a, and (b) a confirm drainage area button 1222b, for confirming data input and/or calculated drainage area 20 for processes 620, and 623, and for advancing to a next associated process (e.g., process 624).
verify rainfall data screen 1224 is associated with processes 624, 625a and 625b, and further comprises: (1) a geolocation map 1221′ displaying pin 1221a associated with geolocation 16; (2) a verification bar 1226 for verifying an amount of rainfall at geolocation 16, further comprising an data display/entry area 1126a (which may be used to manually enter rainfall data or automatically display data retrieved from an outside source), and a rainfall data lookup toggle 1126b (which toggles the options for rainfall data entry between, e.g., manually enter rainfall data or data retrieved from the outside source, such as a rainfall atlas); and (3) a confirmation bar 1228, further comprising (a) save and view opportunity button 1228a, and (b) a confirm drainage average annual rainfall button 1222b, for confirming data input and/or calculated rainfall data for processes and for advancing to a next associated process (e.g., process 618).

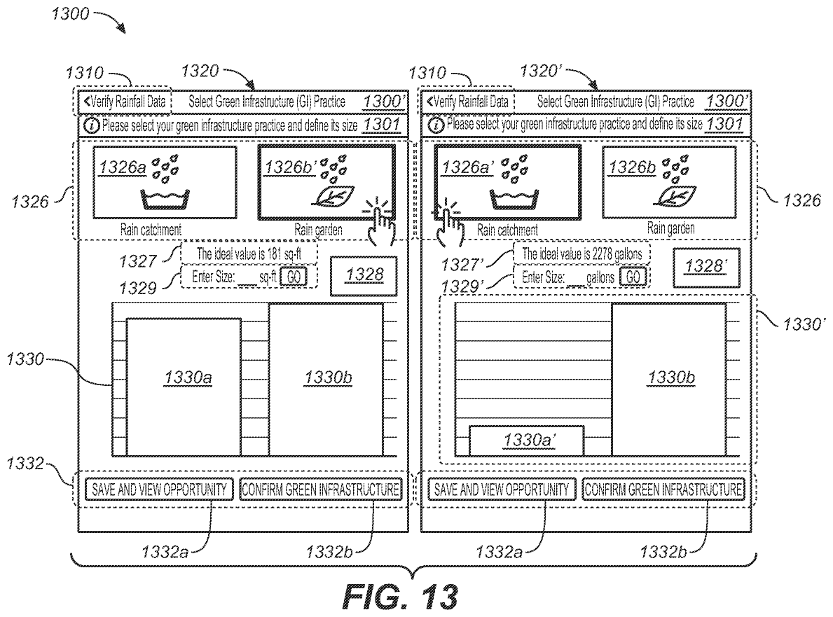

FIG. 13 two alternative screenshots of mobile application GUI 1300 (see also 2310 of FIG. 2B and GUI 800 of FIG. 8) for a user account 504 (e.g., a property owner or other user of the system), illustrating how the system and method described herein may be used for selecting a type of green infrastructure system 26 to be implemented in designing a stormwater management system. In this aspect, for a green infrastructure system option presented, an “ideal size” for that specific green infrastructure system option is provided by GUI 1300, based on prior user input data. In one aspect, a user selects a type of green infrastructure system 26 from one or more options presented, and manually enters a size; in another aspect, an optimal size 27 is computed and used by the system. As described above and shown in FIG. 8, the system produces a bar graph showing the user an expected stormwater runoff volume without a green infrastructure system 26, as well as a potential stormwater runoff volume expected to be captured, based upon the size and type of green infrastructure selected. In some aspects, customer utility fee information such as a fee credit and equivalent impervious area treated or removed may also displayed.

In one aspect, GUI 1300 (including its alternative aspects) comprises: a title bar 1300′; (2) an information/instructions button 1301, for providing a user of GUI 1300 additional information and/or instructions on how to enter information using the displayed GUI screen); and (3) a back button 1310, for returning to the previously displayed screen.

As shown in FIG. 13, for one aspect, each select green infrastructure screen (1320 and, alternatively, 1320′) may be associated with processes 624, 625a, 625b, 626, 627, 628, 629 and 632; thus, each screen further comprises: (1) an listing of icons 1326 displaying various types of green infrastructure systems (e.g., rain catchment 1326a, rain garden 1326b, etc.) and prompting a user selection for a type of green infrastructure system 26; (2) an ideal value display 1327, for displaying an optimal size 27 (for selected green infrastructure 26), as computed by process 627; (3) a size entry location 1329, for manually entering a size (capacity) of selected green infrastructure 26; (4) a bar chart 1330 showing a stormwater runoff volume comparisons for (a) expected runoff 1330a with installation of selected green infrastructure 26, versus (b) actual runoff 1330b without a green infrastructure; and (5) a confirmation bar 1332, comprising (a) save and view opportunity button 1332a, and (b) a confirm drainage area button 832b, for confirming data input and/or calculations for processes 626, 627, 628, 629, and 632, and for advancing to a next associated process (e.g., process 634 or process 609). GUI 1300 shows how a first selection 1326b′ for green infrastructure system 26 compares with a second alternative selection 1326a′ regarding: (a) expected runoff 1330a (using first selection 1326b′) versus expected runoff 1330a′ (using second alternative selection 1326a′), and with respect to installation of selected green infrastructure 26, versus actual runoff 1330b without a green infrastructure. Display features 1328 and 1328′ are screen elements that may be used to display customer utility fee information such as a fee credit and/or equivalent impervious area treated or removed for the green infrastructure selected.

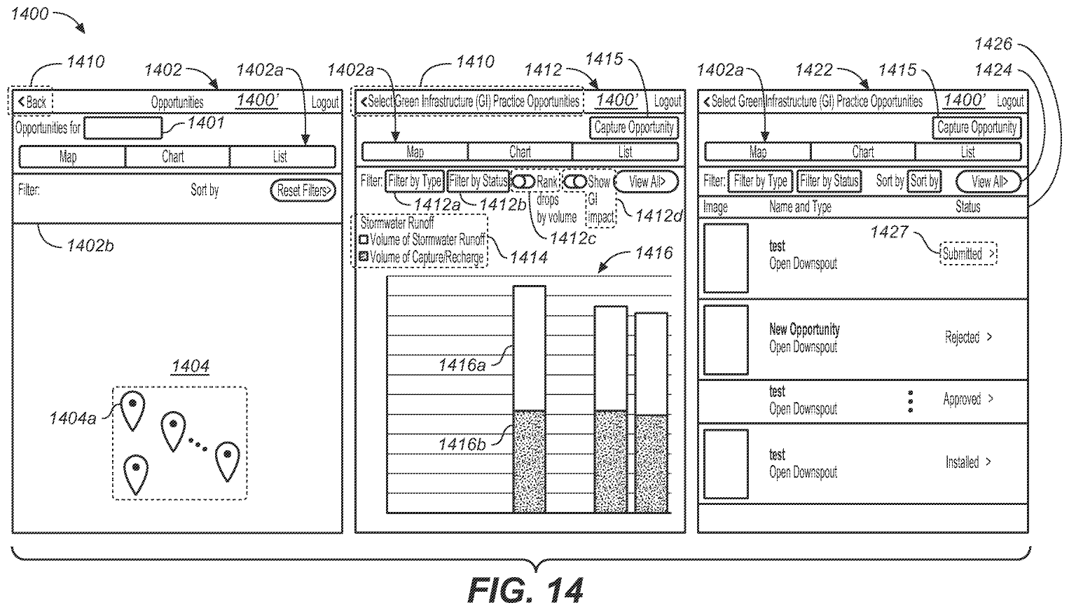

FIG. 14 depicts three screenshots of a mobile application GUI 1400, which may be used for data analysis using the system and method of the present subject matter described herein. In this aspect, multiple “opportunities” can be collected, aggregated and compared; GUI 1400 is associated with processes 630, 632, 634 and 608 (FIG. 6). Referring to the summary interfaces shown in FIG. 14, one aspect includes a map summary interface 1402, a chart summary interface 1412, and a list summary interface 1422. Using these summary interfaces, data and information created and/or stored in mobile device 2300 (FIG. 2B) and/or server system 2400 (FIG. 2B) can be filtered by type of drainage mechanism 14 identified to be converted to green infrastructure 26, by status of a green infrastructure project 30, or by other filters, some examples of which are herein described.

Thus, for example, and as shown in map summary interface 1402 (and as associated with process 611, see FIG. 6), in “Map” view, a set of geolocation pins 1404a are displayed on a map 1401, each such based on a geolocation 16 for a green infrastructure project 30 saved in the system described herein. As shown in FIG. 14, the set of pins 1404a represents each “opportunity” (green infrastructure project installed or proposed) collected; color (not shown) may be used to represent different types of opportunities (based on, for example, drainage mechanism 14 identified for a given geolocation 16).

Aggregated information 2410 (see FIG. 2B), which may relate to one or more opportunities, shown can also be viewed in “Chart” mode using, for example, chart summary interface 1412 (and as associated with process 611, see FIG. 6). Such aggregated information can be organized, for example, by (a) type of drainage mechanism 14 to be retrofitted with a green infrastructure, (b) green infrastructure system type 26, or (c) project status and ranked by stormwater runoff volume and its green infrastructure impact to reduce the stormwater runoff. Thus, as exemplified in FIG. 14, in one aspect, filter buttons 1412a, 1412b, 1412c and 1412d may be used, respectively, to alter the display of aggregated information on a stacked bar chart 1416 (displaying, by way of example, stormwater runoff comparisons 1414, comprising a stacked bar representing stormwater volume runoff (1414a) plus capture/recharge (1414b) for each opportunity graphed.

Finally, in one aspect shown, list summary interface 1422 shows a “List” view of aggregated information 2410, which allows a user/admin to see the status 1427 of one or more green infrastructure projects listed for one or more opportunities, and enables the user/admin to make edits or updates (as associated with process 611, see FIG. 6).

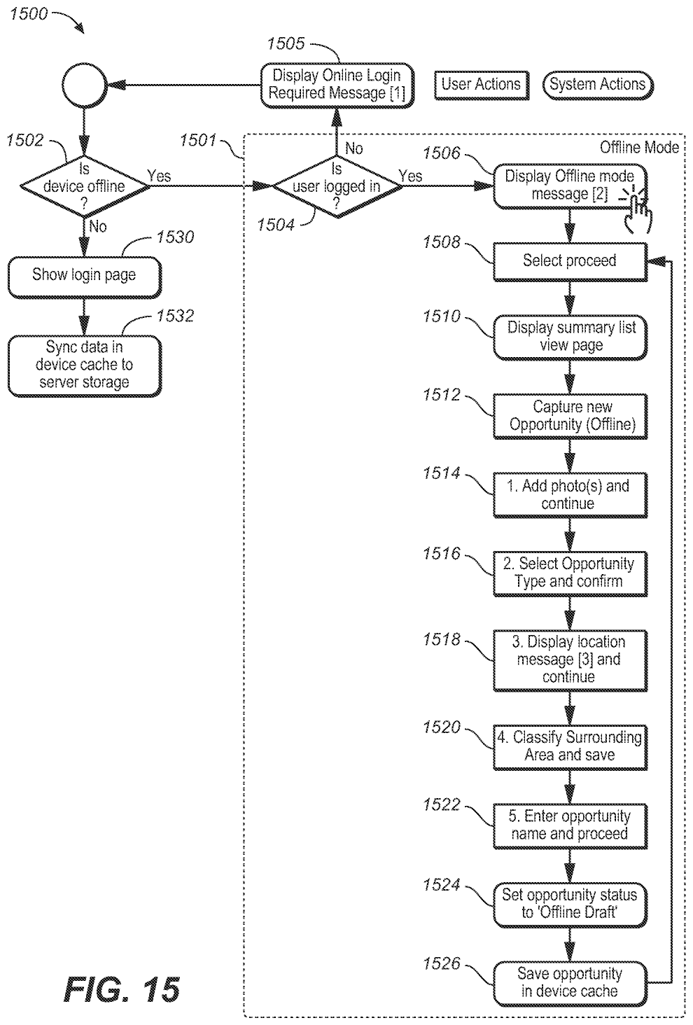

FIG. 15 is a flowchart illustrating one aspect of an offline mode using the system and method of the present subject matter described herein. In this aspect, should the user be located outside of a WiFi coverage zone while collecting input data, the mobile application 502 of mobile device 2300 provides an offline process 1500—to allow the user to collect data in the field using mobile device 2300 and mobile cache 2305, which data can be synchronized with server system 2400 and analyzed later when back in a WiFi (or cellular) coverage zone. In one aspect, offline process 1500 comprises a process 1502 that checks if mobile device 2300 is offline: if it is, then the user is permitted to login (via process 1504) for offline mode 1501 use; if not, then mobile device 2300 displays a login page (process 1530) to enable the user to login to the system and, after successful login, the system automatically synchronizes opportunity data and information collected and stored in cache 2305 during offline mode 1501.

In one aspect, during offline mode 1501, a user is able to: (1) capture an “opportunity” photo 12; (2) identify a type of drainage mechanism 14 (icon interface); (3) classify a surrounding drainage area 20; and (4) enter an opportunity name 30. Data collected is then stored as an “Offline Draft” in mobile device 2300 cache 2305 (FIG. 2B); once back online, the user may select opportunity 30 from a “List View,” and is able to use other mobile application functions of the system to complete the data collection and analysis for opportunity 30, which was identified by name for the data collected offline.

Thus, as shown in FIG. 15, in one aspect, of offline process 1500 comprises offline mode 1501, which further comprises:
Process 1504: Checks if the user if offline (i.e., no access to server 2400), of so, then proceeds to process 1506.
Process 1506: Displays “Offline mode” message; continues to process 1508.
Process 1508: Allows user to proceed offline; continues to process 1510.
Process 1510: Displays summary list view page (but only shows offline draft opportunities associated with user account 504).
Process 1512: Captures new Opportunity (Offline) and proceeds to process 1514.
Process 1514: Adds photo(s) and continues to process 1516.
Process 1516: Selects Opportunity Type and confirm; continues to process 1518.
Process 1518: Displays location message and continues to process 1520.
Process 1520: Classifies Surrounding Area and saves—“Confirm surrounding area” button will be hidden and only “save and view opportunity” button will be displayed; continues to process 1522.
Process 1522: Enters opportunity name; proceeds to process 1524.
Process 1524: Sets opportunity status to “offline draft”—Once all data is entered completely back in online mode, opportunity status will to “draft”. The status update will occur on the following screens, as it currently does in online mode, when the user selects ‘Save and View Opportunity: 1. Add Drainage Area screen; 2. Verify Rainfall Data screen; 3. Select Gl Practice screen; permits “Status filter” on the Summary screens (List, Map & Chart) to be extended to include a filter for ‘Offline Draft’; continues to process 1526.
Process 1526: Saves opportunity in device cache 2300—returns to process 1508.
Process 1532 After successful login, synchronizes all opportunity data and information in device cache 2304 to server database 2405.

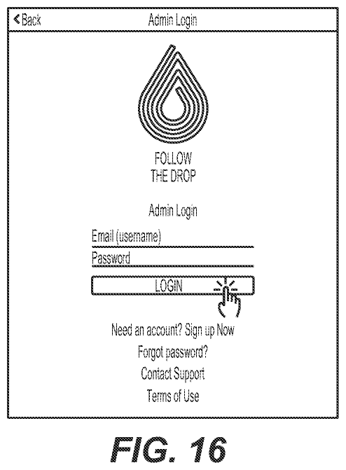

FIG. 16 is a screenshot of a mobile application GUI for an administrator of the system, which may be used as an administrator login feature using the system and method of the present subject matter described herein, notably, in conjunction with GUI 700 of FIG. 7 (describing “Admin” login feature 702 and admin registration feature 704) and process 607. Once an administrator logs into the system, the administrator may view opportunity data and information, along with and data analysis screens (e.g., as in GUI 1400 (FIG. 14), for user accounts registered under the same Class ID 702a as the administrator.

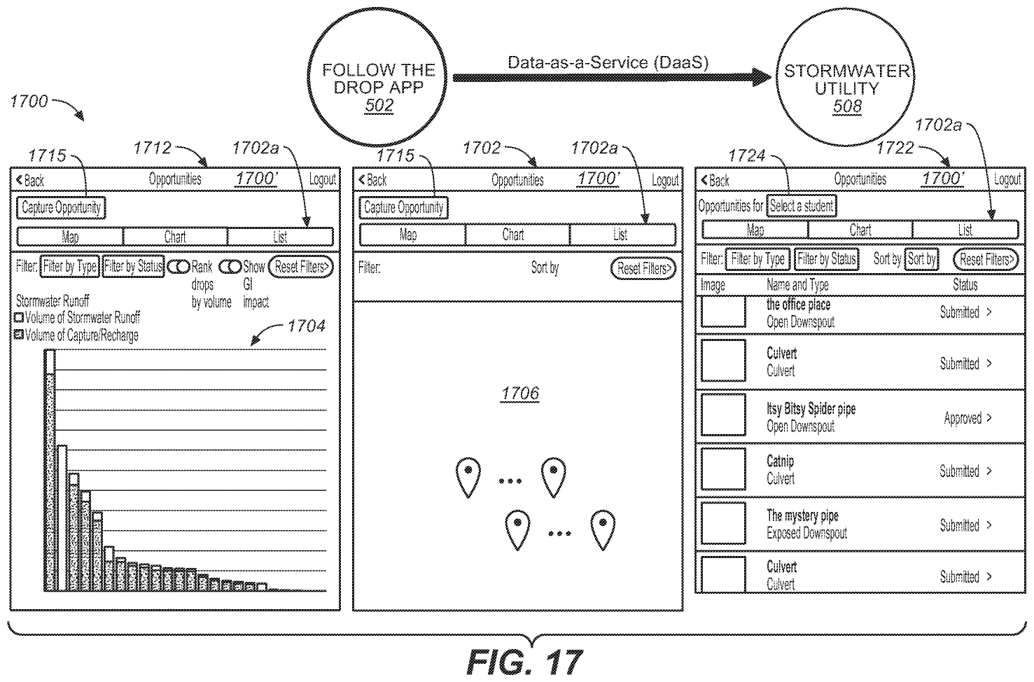

FIG. 17 depicts three screenshots illustrating how GUI 1400 of mobile application 502 may be used by a stormwater utility 508 to (a) monitor stormwater runoff reduction for one or more green infrastructure projects, (b) associate one or more green infrastructure projects with rebates, grants and/or utility fees reductions at a geolocation, and (c) facilitate asset management for stormwater management systems. In this aspect, mobile application 502 provides a “Data-as-a-Service” (DaaS) operating model via the computer-implemented system and method described herein, wherein compiled and aggregated information 2410 is associated with one or more green infrastructure systems at one or more geolocations, (d) track the status of green infrastructure projects for example “submitted”, “approved”, “installed”, “maintained.” As shown in FIG. 17, the DaaS model allows stormwater utility 508 to (a) access aggregated information 2410, and (2) display the aggregated information 2410 for data analysis and comparison purposes, using the system and method of the present subject matter described herein. In this aspect, multiple “opportunities” can be collected, aggregated and compared; summary interfaces—including, for example (also shown in FIG. 14), a map summary interface 1702, a chart summary interface 1712, and a list summary interface 1722—for a plurality of green infrastructure systems and/or projects may be available to an administrator for monitoring stormwater green infrastructure and asset management, allowing an administrator to visualize and analyze data and information aggregated from user input data and transmitted to the mobile application of the system and method of the present subject matter. The data analytics allows an administrator to review user data in List, Map and Chart modes, and change the status indicator of the green infrastructure project designed using the system and method described herein, and apply utility fee reductions 2412 (and/or rebates) for a customer, based upon aggregated information 2410 derived from that customers user account 504.

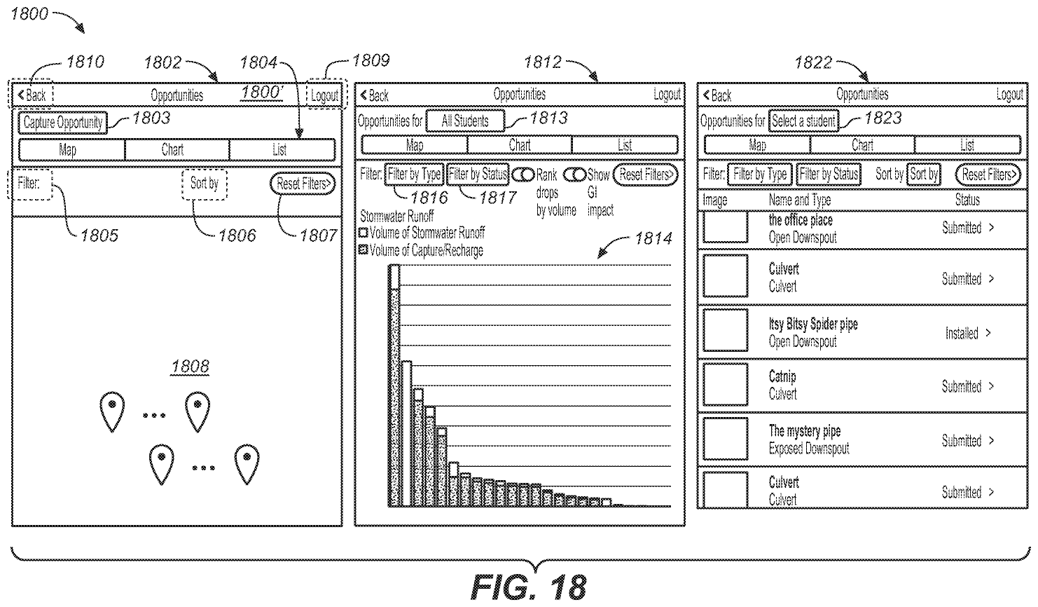

FIG. 18 provides closer views of screenshots shown for the aspect shown in FIG. 17, showing exemplary output data analysis and information available to an administrator for aggregated input data entered by users and transmitted to the mobile application of the system described herein. In this aspect, an “Admin Home Screen” provides Map, Chart, and List views, using the system and method of the present subject matter described herein. In this aspect, once logged in, an administrator can review user input data and processed information from various viewpoints (such as, Chart, Map, and List), with the same functionality as the users, to view individual and/or aggregated data; the system enables the administrator to change the status indicator of the users' saved projects (which may include, for example, “Draft,” “Final,” “Installed,” or “Maintained”).

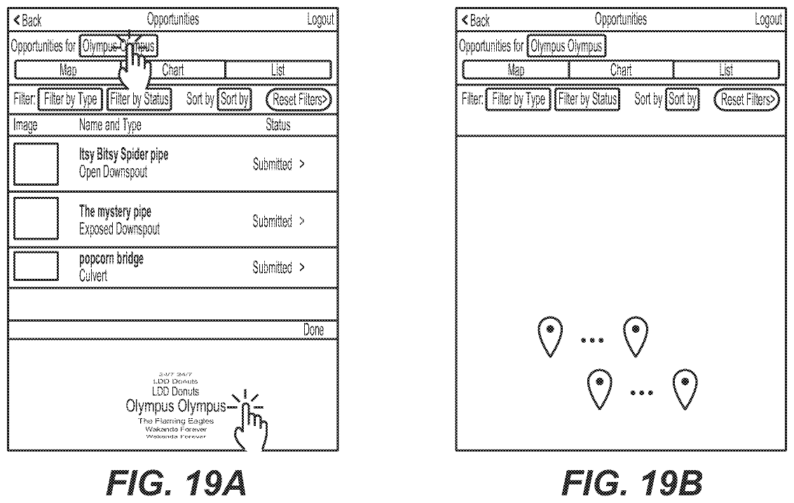

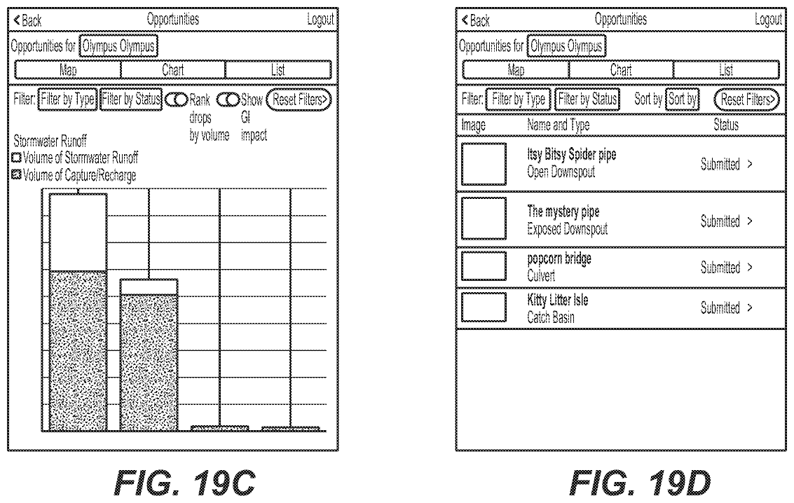

FIGS. 19A, 19B, 19C and 19D collectively depict four screenshots of mobile application 502 GUI for an administrator generally, illustrating one aspect of how an administrator may view user input data using the system and method of the present subject matter described herein. In this aspect, the administrator can select a user account 504 to view that user's specific input data collected, computed, and aggregated. The administrator is permitted to make changes to the user's input data entries (via process 611, FIG. 6), should the user's input data need correction, or to flag data entries as a method of quality control over the data. Input data in this viewpoint can be reviewed to assess, for example, if a given green infrastructure project could qualify for a utility rebate/fee reduction. For example, the system may be used to facilitate estimating utility fee reductions and/or eligibility for grants or rebates for the type and size of a green infrastructure design solution a system user selects, and such estimates may then be communicated to support municipal stormwater utility billing systems, via one or more communication links to municipal or other government databases (further described below).

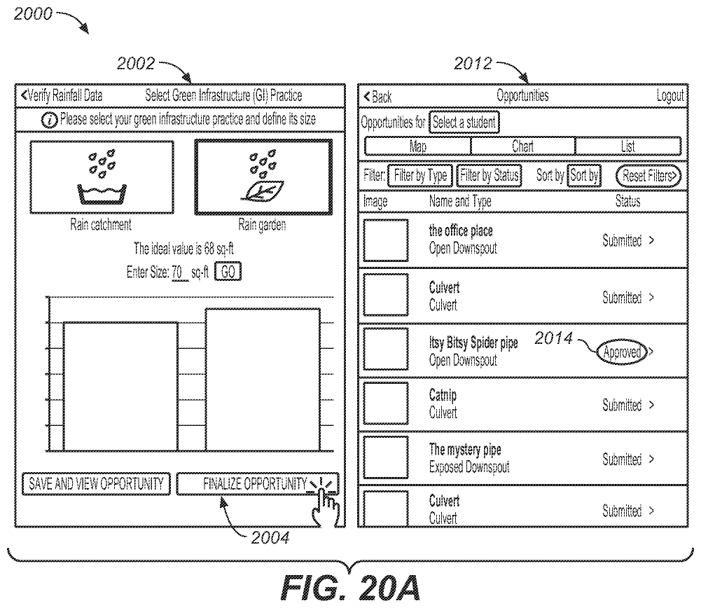

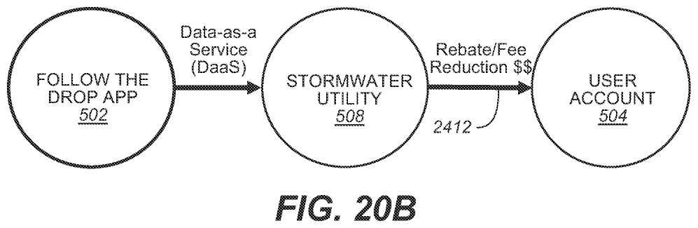

FIG. 20A and FIG. 20B illustrate one aspect of how an administrator may finalize data using the system and method of the present subject matter described herein. FIG. 20A depicts two screenshots of a mobile application GUI 2000 for an administrator, illustrating one aspect of how an administrator may finalize data, which is stored in database 2405 (FIG. 2B), using the system and method of the present subject matter described herein. In this aspect, after reviewing a user's aggregated information 2410 (FIG. 2B) for opportunity 30 which has been collected and processed by mobile application 502, the administrator can change the status indicator 2014 of that user's green infrastructure project 30 from “Draft” to “Final.” The intention of the administrator in reviewing the user's aggregated information 2410 and making green infrastructure project 30 “Final” provides an elegant method of data management, allowing a level of review to distinguish good data from bad data when stored in the server system's database 2405 (FIG. 2B). This feature may also be used to identify projects qualifying for utility rebates and/or fee reductions 2412 to user accounts of mobile application 502, as illustrated in FIG. 20B. Moreover, once a green infrastructure project 30 has been installed, the administrator may change the status indicator 2014 of that project to “Installed” and, following installation, may review green infrastructure project 30 and update its status indicator to “Maintained.” Updating status indicator 2014 correlates to a recorded date and time, which is also stored in database 2405 (FIG. 2B) of the system described herein. In one aspect, database 2405 is included in an application infrastructure of a cloud-based system, such as Amazon Web Services (AWS).

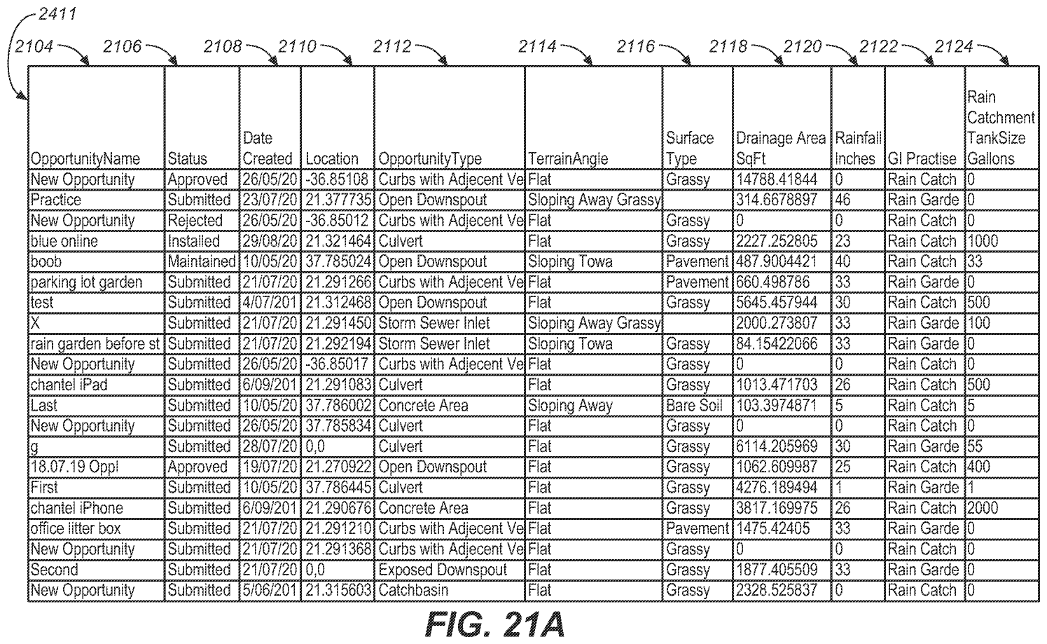

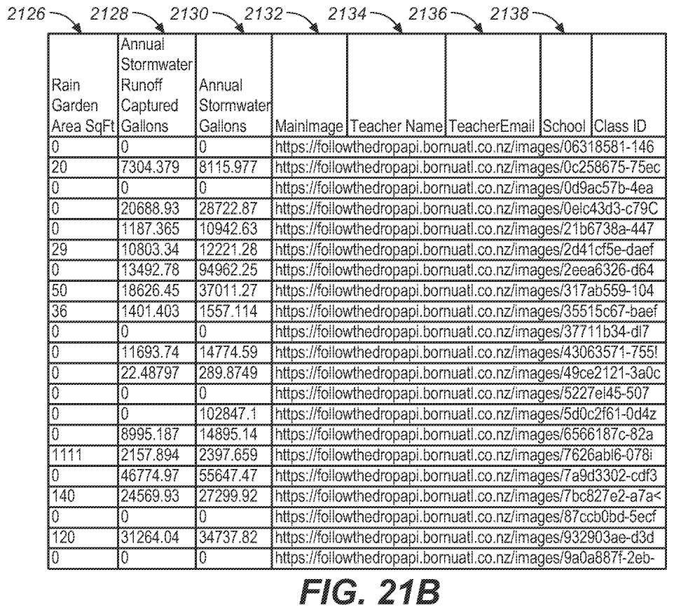

FIGS. 21A and 21B (collectively) is a table illustrating one aspect of data storage and data management using the system and method of the present subject matter described herein. In this aspect, input data collected from a mobile application user is organized and stored in a database, which allows to process information associated with the user's input data and to perform and aggregate data analytics. In this aspect, the mobile application enables offering Data-as-a-Service (for the user input data collected) for stormwater utilities, large landowners, or agencies interested to track and monitor locations and volumes of stormwater runoff, as well as the preferences, sizes and locations of green infrastructure projects.

In one aspect, and as shown in FIGS. 21A and 21B (collectively), data collected and stored in a database record includes:

Registered Administrator
Name 2134
Email address 2136
School ID 2138
Class ID 2140

Similar identifying information for a Registered User (not shown) is also stored
Name
Email
School ID
Class ID

In one aspect, Admin/User data captured, collected, or otherwise entered as input data, organized for an opportunity and stored as records in the database includes:
Opportunity name 2104
Status 2106 of the project (Draft, Draft offline, Final, Installed or Maintained)
Date 2108
Location 2110 (geolocation latitude/longitude for opportunity)
Opportunity type 2112 (drainage system selected to be modified to green infrastructure)
Surrounding Area terrain 2114 (selected)
Surrounding Area surface type 2116 (selected)
Drainage area 2118
Rainfall data 2120 (annual)
Green infrastructure (GI) system 2122 (practice selected by the user)
GI Size 2124 (rain catchment), 2126 (rain garden) (auto-calculated by mobile application for the GI selected, or a size that the user inputs manually)
Stormwater runoff volume 2128 (annual gallons)
Stormwater runoff reduction 2130 (annual gallons)
Photo 2132

Optional features not shown in the above-listed features, including:
Auto-calculate the amount of impervious area treated or reduced based on green infrastructure (“GI”) size identified. This may be done by internal modeling calculation in the system;
Include a “trash” option in “Confirm Opportunity Type,” show results in “Map View” and “List View,” and add “Trash” to “Filter by Type.” Input data entered by a user is stored in a database to track occurrences of trash/litter in communities; once addressed, the user and/or administrator can change the status can be changed (e.g., to “resolved”);
Include a “flooding” option in “Confirm Opportunity Type,” showing results in “Map View” and “List View.” “Flooding” may then also be included to “Filter by Type;” input data that is collected is stored in the database, thereby allowing to track occurrences of flooding in communities;
Include additional green infrastructure options—such as, for example, a green roof, dry well, bio-filter, bio-swale and permeable pavement—as options to “Select Green Infrastructure” aspect;
Auto-calculate an “optimal value” for these new green infrastructure options by sizing the systems based on embedded modeling in the system. Display animated stormwater runoff reduction (blue bar graph) based on a green infrastructure size the user inputs (“enter size”), with embedded modeling calculating associated stormwater runoff volume captured;
Add amounts of nitrogen, phosphorus, and/or total suspended solids (TSS) captured as bar graphs. Embedded modeling in the system uses values of concentrations of nitrogen, phosphorus and TSS that are often part of the first flush volume of stormwater runoff from a property, and based on the stormwater runoff volume computed by the system, the system outputs baseline concentration values for nitrogen and phosphorus in the associated stormwater runoff. When the “Show N&P Impact” toggle is “on,” the concentrations of these elements will appear in chart mode, and their values will automatically populate. When the “TSS Impact” toggle is “on,” the concentrations of total suspended solids will appear in chart mode, and its values will automatically populate.
Add toggles in a summary chart page for “show N&P impact” and “show TSS impact.” Add toggles for “show N&P impact w/o GI,” “show TSS impact w/o GI” and others for “show N&P impact w/GI” and “show TSS impact w/GI.” Based on the size and type of green infrastructure system 26 selected, and associated stormwater runoff captured, the system predicts how much of the nitrogen and phosphorus and/or total suspended solids concentrations are also captured. A user or administrator is able to click on nitrogen and/or phosphorus and/or TSS bar graph, and the concentration value and percent of the total amount captured of that element is displayed in a popup, based on the size and type of green infrastructure system 26. When these toggles are turned “on,” the mobile application automatically changes its interface from displaying stormwater runoff volumes to charts displaying nitrogen and/or phosphorus concentrations. The nitrogen and phosphorus concentrations are added as additional options to “Filter by Type” (as “nitrogen only” and “phosphorus only”). A totalizer also appears, showing pounds N&P exported, with and without a size and type of green infrastructure system 26.
Create an option for the system to sync to a specific local rain gauge database directly. Create an interface with a calendar for a user to select start and end dates to receive total rain volume. Dates entered correlate to those in a local rain gauge database and sum the total rainfall during the period of time the user selects. This total to be used in the system to compute stormwater runoff volume “without GI” (tan bar graph), and will update stormwater captured volume with the type and size of the green infrastructure system 26 selected (blue);
Update “filter by type” drop down menu to include an option for showing “local rain gauge data only;”
Create an additional interface similar to “draw drainage area 20,” in which the user is prompted to draw an area where a proposed green infrastructure (“GI”) system will be installed. Include a polygon option to draw the area in a map view for the drainage area 20 of the selected green infrastructure system 26 (except rain catchment tank); the polygon will auto-populate the drainage area 20 of the green infrastructure system 26 and, after the user confirms size, this value auto-populates the “enter size” for the green infrastructure system 26 selected. This entry for the drainage area 20 (size) of green infrastructure system 26 is used by the system to compute stormwater runoff, and nitrogen and phosphorus captured, based on the type and size of the green infrastructure system 26 selected and area drawn with the polygon tool.
Include Artificial Intelligence (AI): AI is used to auto-calculate impervious surfaces in a Tax Map Key (TMK) or defined space by the user, and provides the total area of impervious surfaces within that defined area. The user may select a building roof in the defined area, for example, and AI recognizes the building roof and auto-populates its area. The user may choose to continue to use the polygon tool to draw the drainage area 20, and another tool in the system provides the area value. Using AI, the system outputs a percentage of the area drawn or selected by the user relative to the total impervious area in the defined area. The data is output as a percentage of the total.
Update photos and status in list view to use the mobile application as an asset management tool. A user/administrator is able to take a photo 12 of a GI project to confirm installation and/or maintenance, for example, and submit update(s) to the green infrastructure project status (e.g., “installed” or “maintained”); a date and time will be recorded in the system's database and displayed via the mobile application. The user/administrator may include additional notes when these status updates occur.
Allow a user to change parameters for GI sizing such as, for example: soil coefficient; percentage of impervious area; drainage rate; retention rate; engineered soil type and depth; and
Couple the mobile application the system described herein to a smart home system (such as, for example, a home dashboard, Siri, Alexa), to enable a user to obtain real-time stormwater runoff and capture volumes for a property location address, as programmed into the mobile application, which is informationally coupled to a local rain gauge.

3. System Architecture Used for Designing a Stormwater Management System Using Green Infrastructure Systems

Various hardware elements used to implement one aspect of the system will now be described.

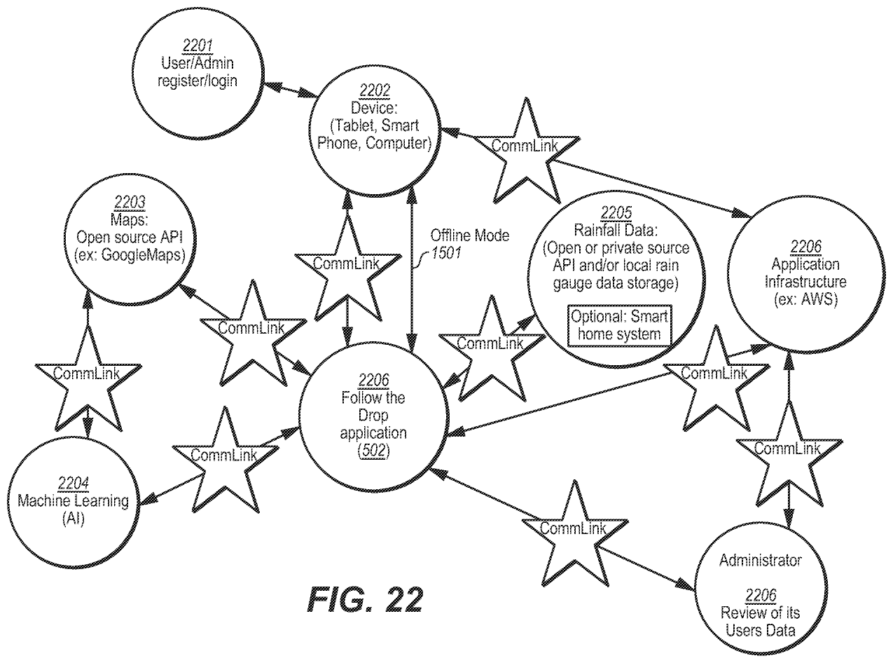

Referring to FIG. 22, one aspect of a system architecture used for designing a stormwater management system using green infrastructure systems includes: (1) user input device options—tablets, smartphones, laptop computers, or other hand held (or mobile) devices with incorporated camera and touch screens or other input device, with or without digital pen, and computer processing units (CPUs); (2) administrator device options—same as user, and also a desktop computer system (with input devices, displays, etc.); (3) storage systems (databases, data warehouse, cloud-based storage, application infrastructure, local servers, remote servers); (4) Internet, Ethernet, WiFi, Bluetooth, cellular network, and/or other forms of communication links; (5) computer processor(s) (and their inputs/outputs); (6) smart home system(s); (6) local rain gauge system(s); and (7) communication links between components. Software and/or firmware for implementing various aspects of the method resides on one or more of the system architecture components as shown.

Thus, the methods described herein can be implemented as computer software using computer-readable instructions and physically stored in one or more computer-readable media, as, for example, in the mobile devices and other computer system(s) shown in FIG. 22, suitable for implementing certain aspects of the disclosed subject matter. The computer system includes one or more input devices (for example, keyboard, microphone, mouse, touch screen, touch pad, graphical user hardware interface, digital pen, etc.), one or more output devices (visual output display, audio output device, etc.) a computer processor, and one or more storage devices associated with an application infrastructure.

The computer software can be coded using any suitable machine code or computer language (such, for example, Xamarin, Progressive Web Applications, React Native) that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like. A non-transitory computer-readable medium having stored thereon computer-executable instructions which, when executed by an information processing device, cause the information processing device to perform the actions of the methods described herein is included. The instructions can be executed on various types of computers or components thereof, including, for example, desktop computers, laptop computers, tablets, smartphones or other mobile devices, distributed back-end computer systems; etc.

Referring to FIG. 22, the various components of the system and method illustrated include the following aspects:
2201. User/Admin: Downloads the Follow the Drop application 502 on a mobile device. Admin/User opens the mobile application GUI and registers and logs in. The User can then enter a new opportunity or update an existing green infrastructure project for Admin to update its status or otherwise edit the project.
2202. Login to Follow the Drop application 502 via Internet access. Mobile device provides camera, photo date and time, and location services. (During offline mode, functionality may be limited to, for example, capturing a photo of the opportunity for implementing a green infrastructure system and saving the green infrastructure project. Once back online, the system can complete its functionality.)
2203. Maps data is brought into the mobile application via an API call to the Follow the Drop application 502. While in maps view, the user is able to use a polygon function to draw the drainage area and potential area for their green infrastructure project and; in the aspect shown, the maps tool auto-calculates the area drawn. The area calculated is saved in the Follow the Drop application 502.
2204. A machine learning system reads the maps and identifies each impervious are type (e.g. roof and road surface), and calculates its respective area and total impervious surface area within a property boundary. Data values are pushed to the Follow the Drop application 502 with an APL call from the application.
2205. Annual or sum of rainfall selected by the user over a certain period of time is brought into the mobile application via an API call to either an open source or private rain gage data set.
2206. Follow the Drop application 502 provides icons for selecting gray infrastructure/opportunities to capture stormwater runoff via green infrastructure and means for a user to classify the surrounding area around the drainage mechanism to support the selection of the type of green infrastructure system; calculates and displays the stormwater runoff volumes based on the drainage area and rainfall confirmed by the user; calculates and displays the percentage of impervious area that the green infrastructure project would treat or reduce based off of the machine learning data; calculates and displays the optimum size green infrastructure based on the type of green infrastructure selected from the user and drainage area and rainfall confirmed; calculates the potential nitrogen, phosphorus, and total suspended solids captured, and displays the percent captured; calculates and displays the equivalent impervious area treated or removed; provides the status of the project, and displays the data with ranking, sorting, and status options in map (with droplets of locations of the saved projects); chart; and list view.
2207. Data confirmed and/or saved from 1-6 is stored in an application infrastructure, for example using Amazon Web Services (AWS), that includes (among other features) database management, forgotten password reset options, and data analytics.
2208. An Administrator reviews the data that one or more of its users submitted, and qualifies a user's projects for credits or rebates, and can change a user's green infrastructure project status from “Draft” to “Final,” “Installed,” or “Maintained.” For example, the system may be used to facilitate estimating utility fee reductions and/or eligibility for grants or rebates for the type and size of a green infrastructure design solution a system user selects; such estimates may then be communicated, via one or more communication links to municipal or other government databases, to support municipal stormwater utility billing systems.

The components shown in the schematic illustration of FIG. 22 for a computer system are exemplary in nature and are not intended to suggest any limitation as to the scope of use or functionality of the computer software implementing aspects of the present disclosure. Neither should the configuration of components be interpreted as having any dependency or requirement relating to any one or combination of components illustrated in the exemplary implementation of a computer system for the subject matter described herein.

A computer system for implementing certain aspects of the described subject matter may include certain human interface input devices responsive to input by one or more human users; it may also include certain human interface output devices. A suitable computer system for implementing aspects of the described subject matter can also include an interface to one or more communication networks. The computer readable media can have computer code thereon for performing various computer-implemented operations. The media and computer code can be those specially designed and constructed for the purposes of the present disclosure, or they can be of the kind well known and available to those having skill in the computer software arts. The present disclosure encompasses any suitable combination of hardware and software for implementing aspects of the subject matter described herein.

4. Advantages of the System and Method

The system described herein provides a mobile system and enables a method to support the placement and optimal size of a stormwater management system that uses green infrastructure. The system and method described herein enables its users to increase the capture or recharge of groundwater resources; it thereby encourages the use of onsite water supplies, reduces the use of potable water for landscaping irrigation and/or indoor use, protects the water quality in limited natural resources, and reduces nescience flooding, aspects that are recognized needs. The system and method described herein also provide a means for an educational device and curriculum that can easily and effectively teach watershed citizenship to school-age children, as well as a community outreach tool that supports green infrastructure incentive programs for municipal stormwater agencies/utilities and property owners and serves as a green infrastructure asset management tool.

More particularly, the system and method described herein enables accurate prediction of stormwater runoff for impervious areas such as those found in urbanized areas, using concepts and methods for developing green infrastructure systems for stormwater management in urban environments.

The system and method described herein offers means for optimizing a green infrastructure design solution, and thus has great value in building resiliency in communities, by meeting regulatory requirements and associated challenges of managing stormwater runoff to protect natural resources (such as streams, lakes, watersheds, coastal areas), supporting future fresh water supply, reducing the occurrence of flooding, facilitating community green infrastructure projects, and providing tools to be incorporated in educational curricula for raising awareness towards responsible watershed citizenship. It provides means for computing an amount of stormwater runoff reduction expected from using a stormwater green infrastructure system device. Because it is easy and intuitive to use, it is well-suited for teaching green infrastructure principles, and for designing single-property (home or facility) solutions for individuals, association, agencies and communities.

Another advantage of the system described herein is that it enables a user of a handheld (mobile) device to incorporate collected field data into a computer-implemented system for analyzing the stormwater reduction impact of a green infrastructure project, as well as volume of stormwater runoff captured by a green infrastructure project. Thus, the technology described herein can readily serve as a means to enable users to obtain utility fee reductions, rebates or credits from governments, insurance or other agencies, as well as a means to enable asset management by those agencies. For example, the system may be used to facilitate estimating utility fee reductions and/or eligibility for grants or rebates for the type and size of a green infrastructure design solution a system user selects, and such estimates may then be communicated to support municipal stormwater utility billing systems, via one or more communication links to municipal or other government databases.

Thus, the system and method described herein provides useful mobility and elegant data entry, aggregation, and analysis tools for design, planning, environmental study, monitoring or asset management purposes; it overcomes the cumbersome and unadaptable user interfaces of related systems that are poorly-suited to a layperson's use, or as an educational tool directed to teaching green infrastructure principles and identifying opportunities to retrofit green infrastructure on a property to students, educators, community groups and property owners. The described system and method offers an elegant mobile solution to the problem of designing a scalable stormwater management system using green infrastructure systems which includes, among other things, (1) computing an optimal size for a green infrastructure system type (e.g., a rain garden or catchment tank) based on a property's drainage area, and (2) computing the amount of annual stormwater runoff reduction expected from using green infrastructure system based on the geolocation using local rainfall data.

What is claimed is:

1. A computer-implemented method for designing a management system for stormwater runoff, the method comprising:
identifying, in a data processing system, a drainage mechanism for channeling rainwater falling onto a property;
classifying, in the data processing system, a surrounding area associated with the drainage mechanism;
determining, in the data processing system, a drainage area associated with the property;
verifying, in the data processing system, a geolocation for the property;
verifying, in the data processing system, an amount of rainfall for the geolocation;
selecting, in the data processing system, a green infrastructure system for capturing stormwater runoff, based upon the drainage mechanism, the drainage area, the surrounding area, and the amount of rainfall for the geolocation;
computing, in the data processing system, an optimal size for the green infrastructure system; and
computing, in the data processing system, at least one value associated with stormwater runoff reduction expected from using the green infrastructure system for managing stormwater runoff at the geolocation.

2. The computer-implemented method of claim 1, wherein the geolocation is verified by GPS coordinates.

3. The computer-implemented method of claim 1, wherein the green infrastructure system is used for filtering stormwater runoff.

4. The computer-implemented method of claim 1, wherein the green infrastructure system is used for retaining stormwater runoff.

5. The computer-implemented method of claim 1, wherein the drainage mechanism is selected from the group consisting of a channeling device, a rain garden, and a catchment tank.

6. A computer-implemented method for monitoring at least one green infrastructure project associated with a stormwater management system, the method comprising:
storing, in a database record, information associated with a captured photo of a drainage mechanism at a geolocation;
storing, in the database record, information associated with a drainage area associated with the geolocation;
storing, in the database record, at least one classifier associated with a surrounding area associated with the drainage mechanism;
storing, in the database record, information identifying a green infrastructure system for managing stormwater runoff at the geolocation;
storing, in the database record, an optimal size for the green infrastructure system; and
storing, in the database record, at least one value associated with stormwater runoff reduction expected from using the green infrastructure system at the geolocation, and
wherein the database record is configured to be accessible to facilitate monitoring stormwater runoff at the geolocation.

7. The computer-implemented method of claim 6, wherein the information associated with the drainage area at the geolocation comprises an amount of rainfall for the geolocation.

8. The computer-implemented method of claim 7, wherein the geolocation is verified GPS coordinates.

9. The computer-implemented method of claim 7, wherein the information associated with the drainage area at the geolocation further comprises a stormwater runoff volume for the drainage area and the amount of rainfall.

10. The computer-implemented method of claim 7, wherein the green infrastructure system is used for filtering stormwater runoff.

11. The computer-implemented method of claim 7, wherein the green infrastructure system is used for retaining stormwater runoff.

12. The computer-implemented method of claim 7, wherein the drainage mechanism is a channeling device.

13. The computer-implemented method of claim 7, wherein the value associated with stormwater runoff reduction is associated with a utility fee at the geolocation.

14. The computer-implemented method of claim 7, further comprising compiling aggregated information associated with the green infrastructure system at the geolocation.

15. The computer-implemented method of claim 14, further comprising:
accessing the aggregated information; and
displaying the aggregated information.

16. A data processing system comprising:
a computer processor;
an input device;
a computer-readable storage device informationally coupled to the computer processor;
a data structure stored in the computer-readable storage device and informationally coupled to the computer processor, wherein the data structure comprises a database record;
executable code embodied in the computer-readable storage device for execution by the computer processor, wherein the executable code, when executing on the computer processor, causes a graphical user interface to be displayed on the input device,
wherein the graphical user interface further comprises
means for capturing a photo of a drainage mechanism at a geolocation of a property,
means for storing, in the database record, information associated with the photo of the drainage mechanism at the geolocation,
means for determining information associated with a drainage area associated with the geolocation,
means for selecting at least one classifier associated with a surrounding area associated with the drainage mechanism, and
means for selecting a green infrastructure system for managing stormwater runoff at the geolocation; and
wherein the executable code, when executing on the computer processor, provides
means for identifying an optimal size for the green infrastructure system, and
means for storing, in the database record, at least one value associated with stormwater runoff reduction associated with the green infrastructure system selected for managing stormwater runoff at the geolocation.

17. The data processing system of claim 16, further comprising a server informationally coupled to the data structure, wherein the server is configured to facilitate a method comprising:
compiling aggregated information associated with the green infrastructure system at the geolocation,
accessing the aggregated information, and
outputting the aggregated information.

18. The data processing system of claim 16, wherein the information associated with the drainage area at the geolocation comprises
an amount of rainfall for the geolocation, and
a stormwater runoff volume for the drainage area and the amount of rainfall.

19. The data processing system of claim 16, wherein the value associated with stormwater runoff reduction is associated with customer utility fee information at the geolocation.

20. A non-transitory computer-readable medium having stored thereon computer-executable instructions which, when executed by an information processing device, cause the information processing device to facilitate aggregating information configured to design a stormwater management system comprising:
means for identifying a drainage mechanism for channeling rainwater falling onto a property;
means for classifying a surrounding area associated with the drainage mechanism;
means for determining a drainage area associated with the property;
means for verifying a geolocation for the property;
means for verifying an amount of rainfall for the geolocation;
means for selecting a green infrastructure system for capturing stormwater runoff, based upon the drainage mechanism, the surrounding area, the drainage area, and the amount of rainfall for the geolocation;
means for computing an optimal size for the green infrastructure system; and
means for computing at least one value associated with stormwater runoff reduction expected from using the green infrastructure system for managing stormwater runoff at the geolocation.
